(19) United States
(12) Patent Application Publication
(10) Pub. No.: US 2006/0274767 A1
(43) Pub. Date: Dec. 7, 2006

(54) System and method for collecting, processing and presenting selected information from selected sources via a single website

(76) Inventor: Robert M. Dessau, New York, NY (US)

Correspondence Address: PILLSBURY WINTHROP SHAW PITTMAN, LLP, P.O. BOX 10500, MCLEAN, VA, 22102, US

(21) Appl. No.: 11/430,145

(22) Filed: May 9, 2006

Related U.S. Application Data
(60) Provisional application No. 60/678,791, filed on May 9, 2005.
(60) Provisional application No. 60/704,886, filed on Aug. 3, 2005.

(51) Int. Cl. H04L 12/56

(52) U.S. Cl. 370/401

(57) ABSTRACT

A computer-implemented system and method that are configured to automatically collect, process, and present, via a single website, specific types of selected information such as, for example, government press releases, speeches, statements and other information obtained from pre-selected websites. As used herein, government information may include press releases, speeches, statements, and/or other government information that may be obtained through the system. The system includes an administrative module, an information retrieval module, and a user interface module.

### RELATED APPLICATIONS

This application claims priority from U.S. Provisional Patent Application No. 60/678,791, filed May 9, 2005, and entitled “SYSTEM AND METHOD FOR COLLECTING, PROCESSING, AND PRESENTING SELECTED INFORMATION FROM SELECTED SOURCES VIA A SINGLE WEBSITE;” and U.S. Provisional Patent Application No. 60/704,886, filed Aug. 3, 2005, and entitled “SYSTEM AND METHOD FOR COLLECTING, PROCESSING, AND PRESENTING SELECTED INFORMATION FROM SELECTED SOURCES VIA A SINGLE WEBSITE.” The contents of both of these applications are incorporated herein by reference.

### BACKGROUND OF THE INVENTION

1. Field of Invention

The invention relates to a computer-implemented system and method that selectively enables collection, processing and presentation, via a single website, of specific types of selected information (e.g. press releases, speeches, statements and other government information) obtained from pre-selected websites.

2. Description of the Related Art

Numerous disparate sources of government information exist. These sources include government websites, intergovernmental agency websites, news websites, and other sources. One problem with existing systems and methods for accessing this information is the need to repeatedly visit numerous sites to stay abreast of the desired information.

General news services exist which enable users to sign up for any news on a given topic. These services suffer from various drawbacks including the fact that they are either over-inclusive (i.e. send much more information than a user wants and/or send duplicates of the same information from different sources), or are under-inclusive in that they do not pull information from all of the relevant sites. Various other drawbacks exist with known systems and methods.

### SUMMARY OF THE INVENTION

Principles of the present invention, as embodied and broadly described herein, provide for a computer-implemented system and method that are configured to automatically collect, process, and present, via a single website, specific types of selected information such as, for example, government press releases, speeches, statements and other information obtained from pre-selected websites. As used herein, government information may include press releases, speeches, statements, and/or other government information that may be obtained through the system.

The system includes an administrative module, an information retrieval module, and a user interface module.

The administrative module may include a site training sub-module, a subscriptions sub-module, and an editing sub-module. The information retrieval module may include a web retrieval sub-module and an indexing sub-module. The user interface module may include a presentation sub-module and a user validation module.

In operation, the training sub-module may enable an administrative user to select certain websites to be used as sources of information for the system. For each selected website, the administrative user may be presented with a series of options to create rules for collecting data from the website. The administrative user may initially navigate to a desired website using an interface provided by the administrative module, and may follow prompts to locate the data within the site. The created rules may include, for example, rules defining how to identify pages that include information to be retrieved, rules defining the format of each release, rules for navigating between releases or pages, and/or other rules.

The subscriptions sub-module may also enable an administrative user to manage access to the system by end users. An end user may attempt to access the system through a website presented by the user interface module. The user may select an option to subscribe to the system, access the system if already a subscriber, and/or set subscription details. The subscriptions sub-module may create user accounts and store access information for each account.

Collected information may be accessed by an administrative user before the information is made publicly available. Editing sub-module enables information to be checked for errors by the administrative user before the information is published.

The information retrieval module may collect, process and/or publish data from the selected websites. The web retrieval sub-module may implement rules, such as the rules created by the administrative user when training the site, to collect data from the website on a scheduled basis. The indexing module may create a searchable index of the retrieved information.

The user interface module may facilitate search and information retrieval by an end user. The presentation sub-module may present a user interface enabling a user to subscribe to the system, or if already subscribed, to perform retrieval options and/or to manage the end user's account. The end user may have the option of requesting a trial membership or purchasing a full membership to access some or all of the collected data. To access the system, the user may be presented with a login screen, and upon entering valid credentials, the user may search for and/or retrieve information that the user is authorized to access. User validation sub-module may be used to validate user credentials. User validation sub-module may also verify the type of access the user is entitled to.

The system and method of the present information enable information from various pre-selected websites to be accessed through a single portal. Information that is retrieved from the website may be cached by the system. Thus, even information no longer available at the original source may be displayed by the system. The system also enables collection from particular websites or portions of a website to be turned off while still maintaining the rules for the particular website. Websites may be trained by navigating to a page containing information to be retrieved. Advanced site training options include the use of forms and spiders.

These and other objects, features, and advantages of the invention will be apparent through the following detailed description and the drawings attached hereto. It is also to be understood that both the foregoing general description and the following detailed description are exemplary and not restrictive of the scope of the invention.

### BRIEF DESCRIPTION OF THE DRAWINGS

FIG. 1 illustrates an overall system diagram, according to various embodiments of the invention.

FIG. 2 illustrates a flowchart outlining a process of creating rules for data collection, according to an embodiment of the invention.

FIG. 3 illustrates a harvesting process, according to an embodiment of the invention.

FIG. 4 illustrates an indexing process, according to an embodiment of the invention.

FIGS. 5-6 illustrate an administrator user interfaces, according to an embodiment of the invention.

FIG. 7 illustrates a site addition user interface, according to an embodiment of the invention.

FIGS. 8A-O illustrate training user interfaces, according to an embodiment of the invention.

FIGS. 9A-D illustrate user interfaces for spidering, according to an embodiment of the invention.

FIG. 10 illustrates an interface for selecting forms, according to an embodiment of the invention.

FIGS. 11-13 illustrate interfaces for processing forms, according to an embodiment of the invention.

FIGS. 14-15 illustrate interfaces for navigating release pages, according to an embodiment of the invention.

FIG. 16 illustrates an interface for setting website properties, according to an embodiment of the invention.

FIG. 17 illustrates a website properties interface, according to an embodiment of the invention.

FIG. 18 illustrates category selection interface, according to an embodiment of the invention.

FIGS. 19-21 illustrate data structures, according to an embodiment of the invention.

FIG. 22 illustrates data collection process, according to various embodiments of the invention.

FIG. 23 illustrates an indexing process, according to various embodiments of the invention.

FIGS. 24-27 illustrate user interfaces, according to various embodiments of the invention.

FIG. 28 illustrates a search and browse user interface, according to various embodiments of the invention.

FIGS. 29A-B illustratea a search results user interface, according to various embodiments of the invention.

FIGS. 30A-30C illustrate save search control panels, according to various embodiments of the invention.

FIGS. 31A-31B illustrate user briefcase interfaces, according to various embodiments of the invention.

FIGS. 32A-32H illustrate account management user interfaces, according to embodiments of the invention.

FIGS. 33A-33C illustrate email notification interfaces, according to various embodiments of the invention.

### DETAILED DESCRIPTION OF THE INVENTION

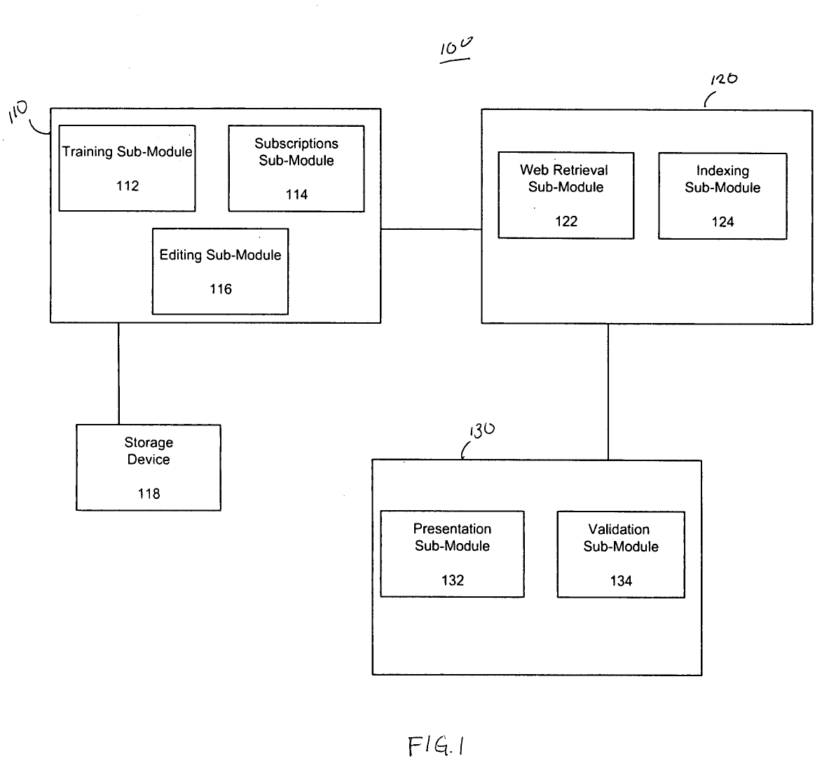

A system according to various embodiments of the invention provides for automated collection, processing, and presentation of government information from various websites such as, for example, government and intergovernmental agency websites. This information may include, for example, press releases, speeches, statements, and other communications. FIG. 1 illustrates an overall system diagram, according to some embodiments of the invention. The system 100 may include one or more modules, for example, an administrative module 110, an information retrieval module 120, a user interface module 130, and/or other modules

The one or modules may interact with one another over one or more communications links over one or more networks. Communications links may include a DSL connection, an Ethernet connection, an ISDN connection, and/or other wired or wireless communications links. Networks may include the Internet, an intranet, a local area network, and/or other networks.

As depicted, for example in FIG. 1, administrative module 110 may include training sub-module 112, subscriptions sub-module 114, and editing sub-module 116. Training sub-module 112 may present a user interface enabling an administrative user to create rules for collecting data from the one or more selected websites. Data may include, for example, a title, a date, a description, a link, text, and/or other data to be collected. Training sub-module may store the retrieved data in a storage device, such as storage device 118.

Subscriptions sub-module 114 may be employed to manage requests from users to access the system and to create subscriptions and set subscription details. For example, subscriptions sub-module 114 may manage licenses, sites, categories, locations, global properties, and/or other management properties. That is, in response to receiving a subscription request, a license agreement may be executed that includes terms such as, for example, a number of users, a subscription length, one or more categories of information to be accessed, and/or other terms. Subscriptions sub-module 114 may enable an administrator to review and manage such subscription requests.

Editing sub-module 118 may enable an administrative user to review data collected by information retrieval module 120 before making the information publicly available. This allows the administrative user to correct any errors such as bad links, improper formatting, partial entries, and/or other errors.

Information retrieval module 120 may be provided for collecting and processing data from selected websites. Information retrieval module 120 may include a web retrieval sub-module 122 and an indexing sub-module 124. Web-retrieval sub-module 122 may be used for collecting data from the selected websites based on rules, such as the rules created by training sub-module 112. Indexing sub-module 124 may be included for creating a searchable index of the retrieved data.

User interface module 130 may be provided, enabling one or more users to access the system. User interface module 130 may include a presentation sub-module that may present a graphical user website making information retrieved available to one or more subscribers. Presentation sub-module may present options to an end user wherein the end user may request a quotation for using the website, apply for a trial subscription, or apply for a full subscription. Subscriptions may vary based on the number of users able to access the subscription, the subject categories available to the subscriber, the period of the subscription, and/or may otherwise vary. A subscription may have one or more users attached to it. One of the one or more users may administer licenses on behalf of the subscription. Other users may update personal details relevant to their account, such as, for example, their names, address, phone number, email address, and/or other personal details.

User interface module 130 may present a login page to the user. When an end user requests a subscription, a user profile may be created and stored in a storage device, such as storage device 118. Validation sub-module 134 may be provided for determining whether the user has entered valid user credentials. Validation sub-module 134 may also determine the level of access the user is allowed based on the user profile. Once logged in, the user may be presented with full web-based text searching capabilities. Information may also be browsed by geographic location and/or subject category. Searches may be saved for later use, and new results added that meet the search criteria may be emailed to the users. Documents, such as releases, may be saved into a folder for later retrieval. The graphical user website will be further described hereinafter.

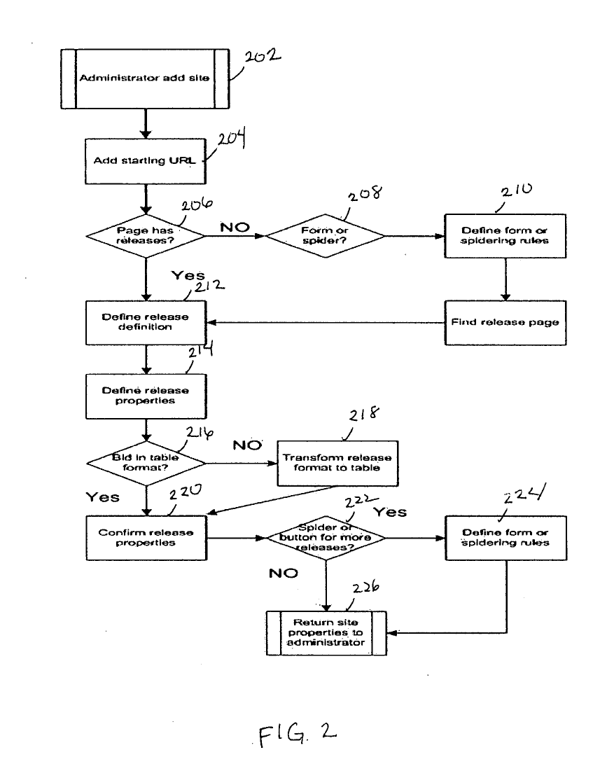

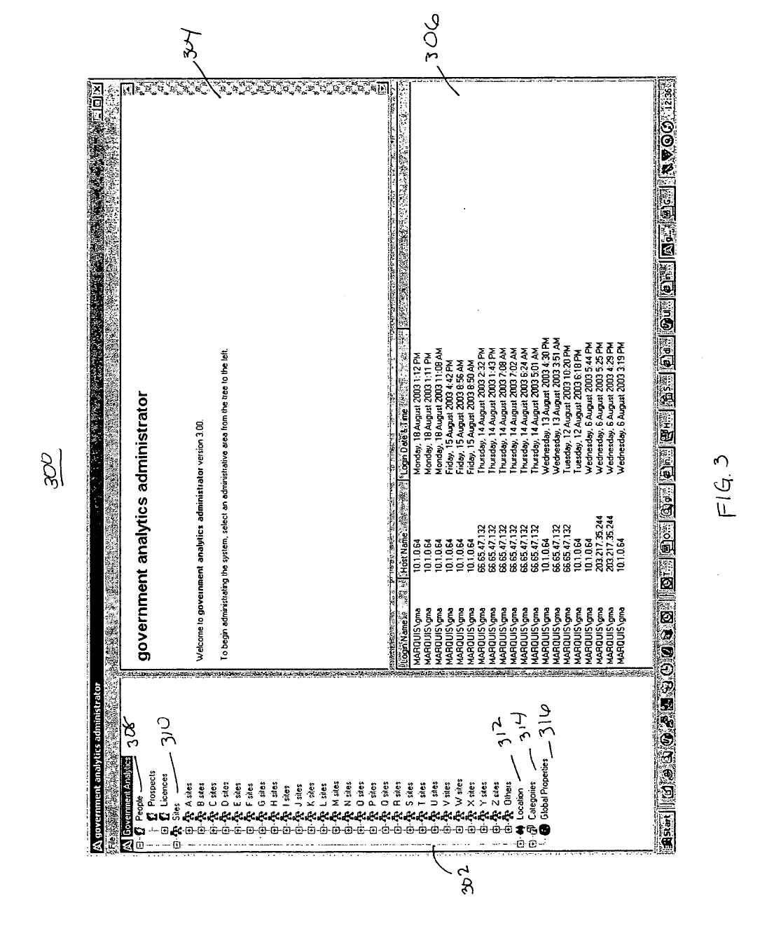

FIG. 2 illustrates process 200 which may be performed by training sub-module 112 for creating rules for collecting data. At operation 202, an administrator may add a website to the system for processing. The administrator may enter a starting universe resource locator (URL), as illustrated at operation 204. The starting URL may be the first page on which one or more press releases may be found. The administrator may allow data to be collected on from the starting page, or may allow other pages within the website to be searched for other data.

As illustrated at operation 206, a test may be conducted to determine whether the entered starting page includes releases. If the starting page does not include releases, a test may be conducted to determine if the page contains forms, or if spidering is required, as illustrated at operation 208. Forms and spidering will be discussed in detail hereinafter and, at this point suffice to say that forms refers to a system utility that completes form on websites and spidering generally refers to a process of storing URLs and indexing keywords, links, and other items of information. If either is present, the administrator may define one or more rules for the form or spidering, as illustrated at operation 210.

Once one or more releases have been found, the release may be defined, as illustrated at operation 212. Rules may be set up such that items are identified in a substantially identical manner on each page or the website. A particular HTML tag (e.g. paragraph or table row) may be nominated as being the source of items. Tags may be ignored at the beginning or end of a page. The tag may be selected by clicking on text on the screen, or by choosing the appropriate tag from an HTML tree.

Once the release has been defined, properties related to the release may be captured, as illustrated at operation 214. Release properties may include, for example, the title of a release, a link to the release, a release date, a description of the release, the text of the release, and/or other release properties. At operation 216, a test may be conducted to determine whether the release text is in table format. If not, the release is transformed into table format, as illustrated at operation 218, and the release properties may be confirmed, as illustrated at operation 220.

A test may be conducted to determine whether spidering should be performed to finding additional releases, or whether a button should be selected to move to a new page of releases within the website, as illustrated at operation 222. If spidering is to be performed, the rules are defined, as illustrated at operation 224. If there are no additional releases within the selected website, the website properties are returned to the administrator as illustrated at operation 226.

In order to perform a training operation, an administrative user may log into administrative module 110 and may be presented with a user interface such as user interface 300 illustrated in FIG. 3. Interface 300 may include one or more panes, enabling an administrative user to manage one or more system elements.

A first pane 302 may be provided having one or more menu trees, enabling an administrator to setup features for one or more system elements. For example, a people menu 308, a sites menu 310, a location menu 312, a categories menu 314, and/or a global properties menu 316 may be provided. Other menus may be provided as would be apparent. Depending on which menu in first pane 302 has been selected, additional panes such as panes 304 and 306 may provide additional information or instruction regarding the selection.

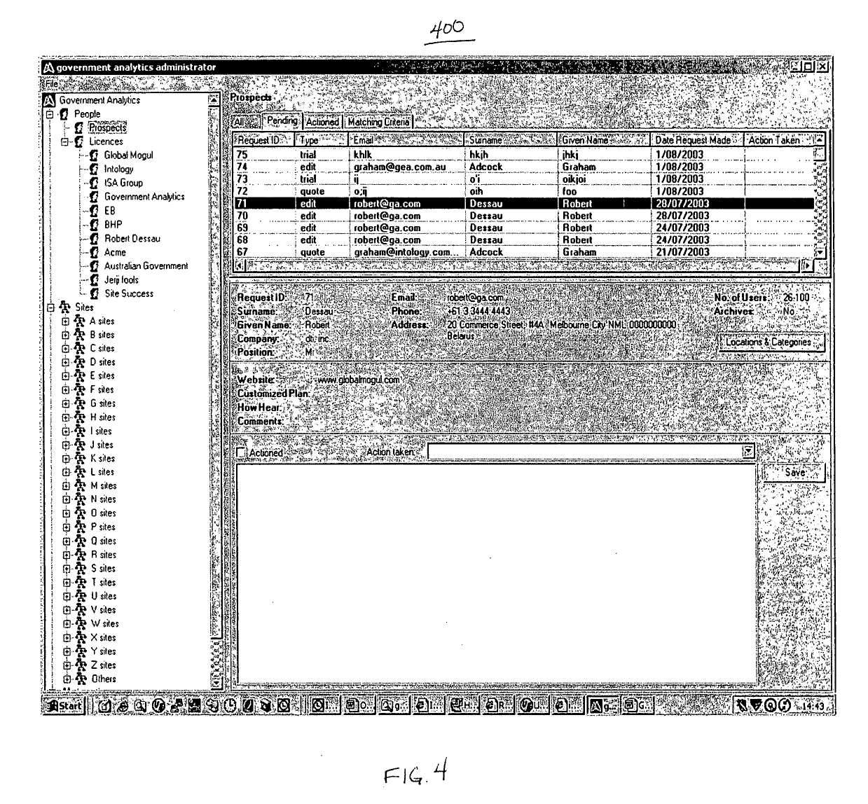

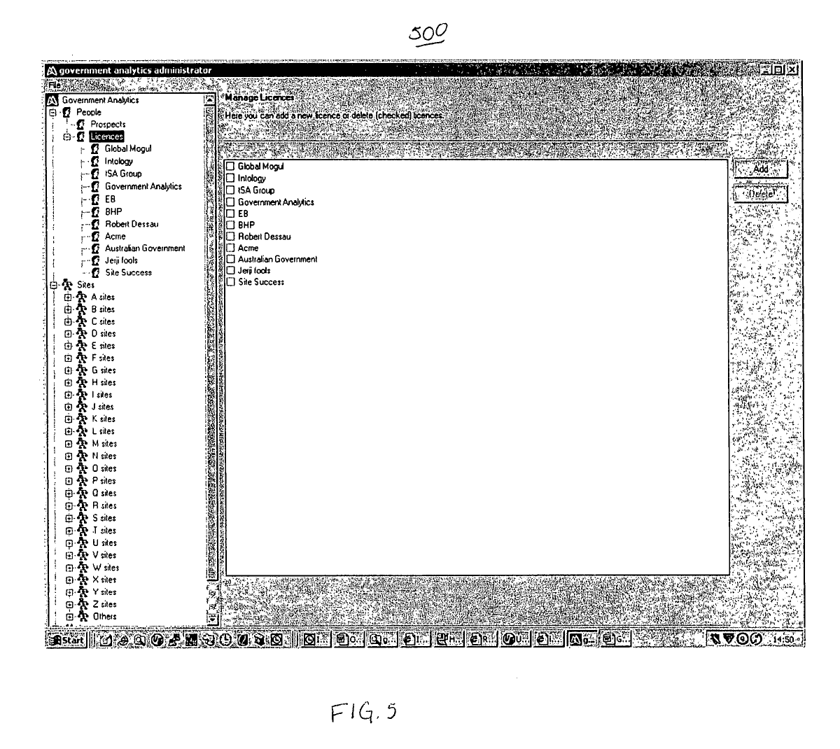

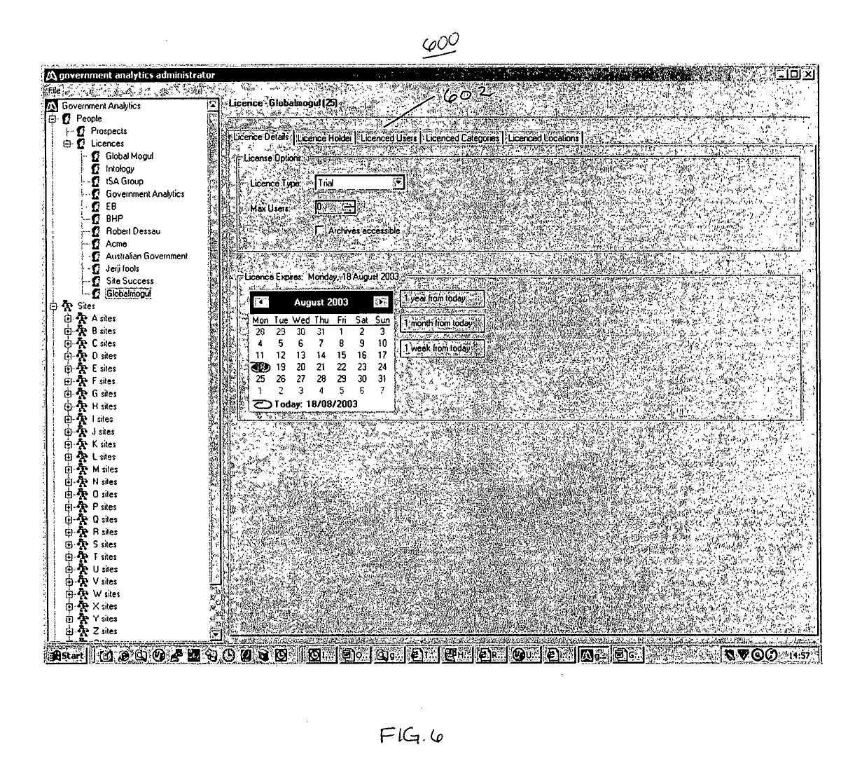

People menu 308 may be used to manage all user accounts for users who have requested a quote from the system website, as well as for adding, deleting, and/or editing licenses. Selecting a prospects option under people menu 308 may present the administrator with a display such as display 400, illustrated in FIG. 4. Display 400 may present a list of users who have requested access to the website. A unique identification number may be assigned to each user. The user's name, address, email address, request date, the type of request made, and/or other user information may be displayed. Type of request may include, for example, a request for quotation, request for trial subscription, request for subscription, and/or other request types.

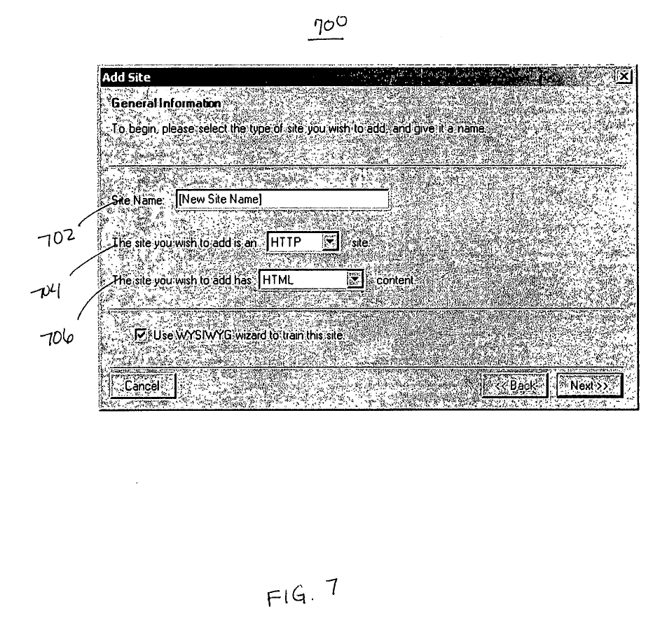

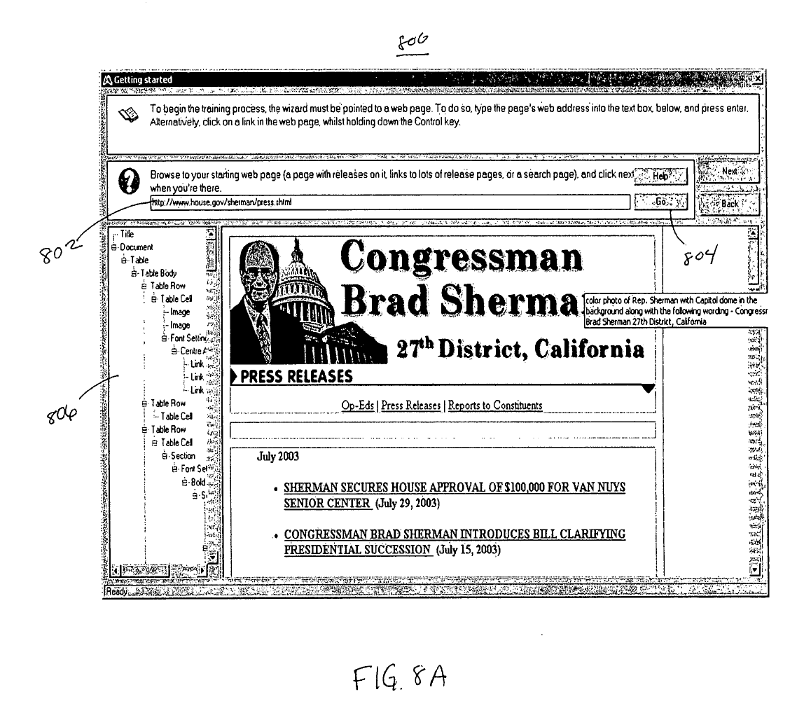

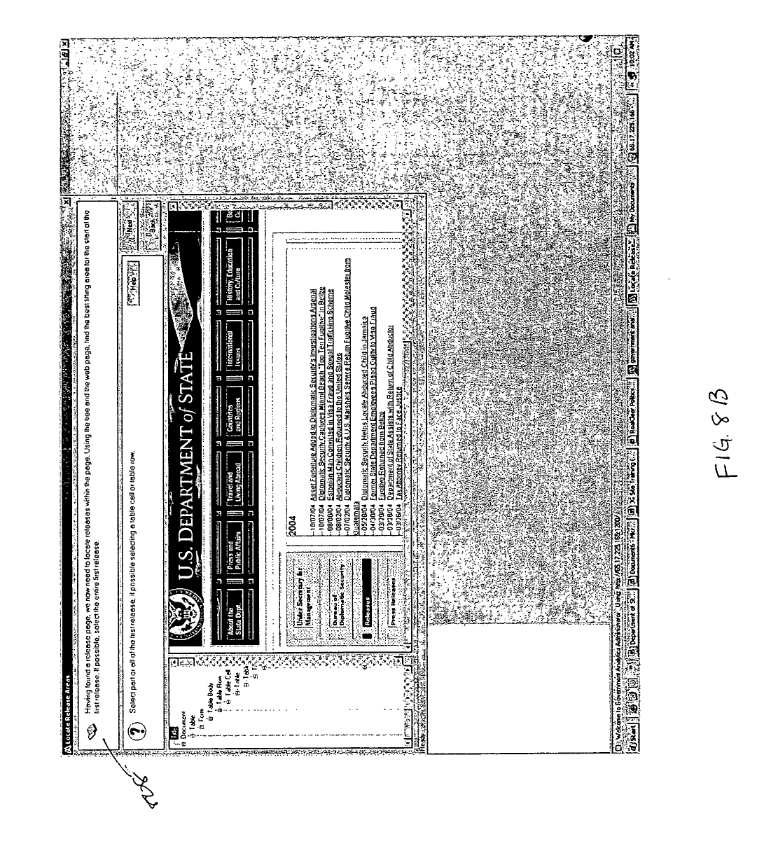

Licenses may be added, deleted, and/or edited by selecting a licenses option under people menu 308. FIG. 5 illustrates a display 500 which may be displayed upon selecting the licenses option. Display 500 may list all current licenses, and may provide options for adding a new license, or for deleting or editing an existing license. Selecting an option to add a new license may present a pop-up window for assigning a name to the new license. Once a name has been entered, a display such as display 600, illustrated in FIG. 6 may be presented, enabling the administrator to set up the license. One or more tabs, such as tabs 602 may be presented enabling the administrator to input information.

A license details tab may present options for selecting a license type. Since a license may entitle more than one user to use the system, a maximum number of users may be selected. A license expiration date may also be set using the license details tab. A license details tab may enable the administrator to enter personal information about the organization and/or person holding the license. Personal information may include an organization name, address, email address, phone number, fax number, and/or other personal information. Users may be added to the license under a licensed users tab. Users may be added individually, and a user name, password, email address, and/or other information may be entered. An option may be presented to classify the user as a license administrator, enabling that user to manage the license. License categories and locations may also be assigned using one or more of tabs 602.

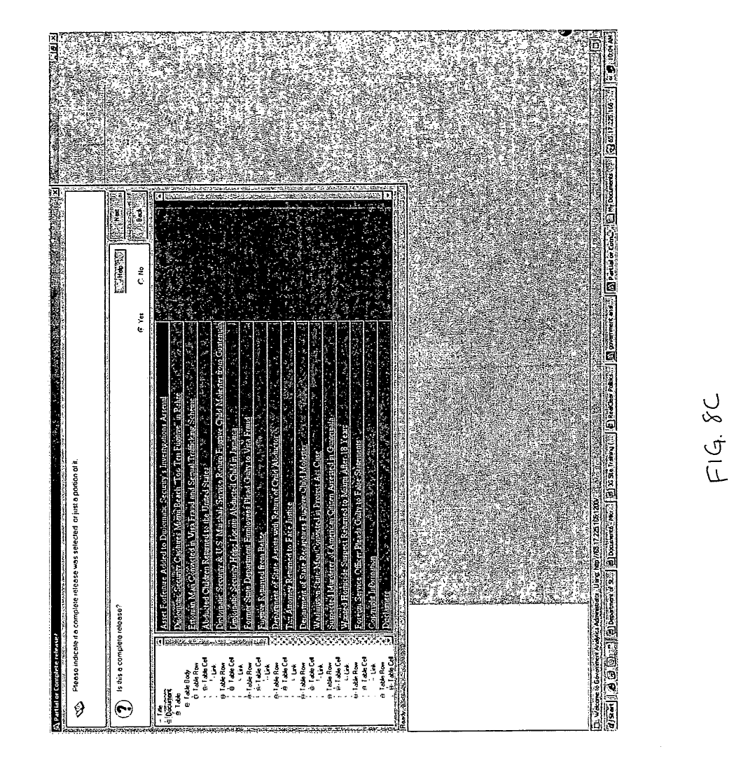

An administrative user may add one or more sites to the system from which releases may be obtained by selecting sites menu 310. A window such as window 700 illustrated in FIG. 7 may be displayed to collect general information about the website to be added. Fields in window 700 may include website name 702, website protocol 704, website content type 706, and/or other fields.

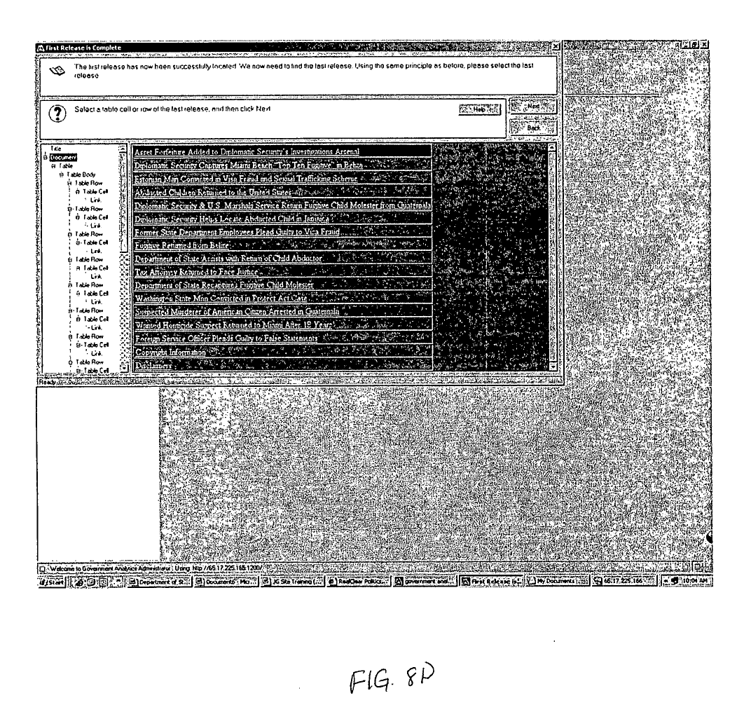

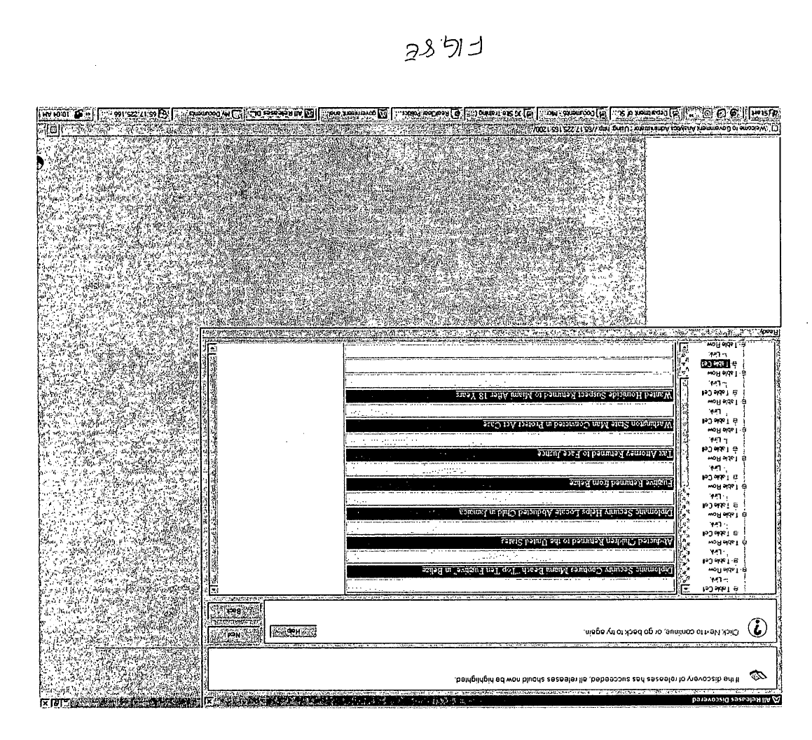

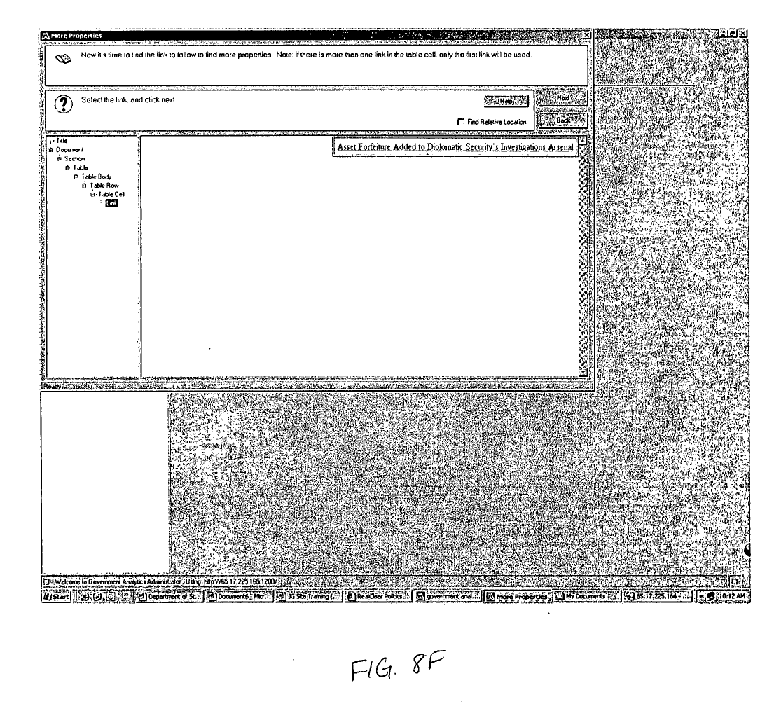

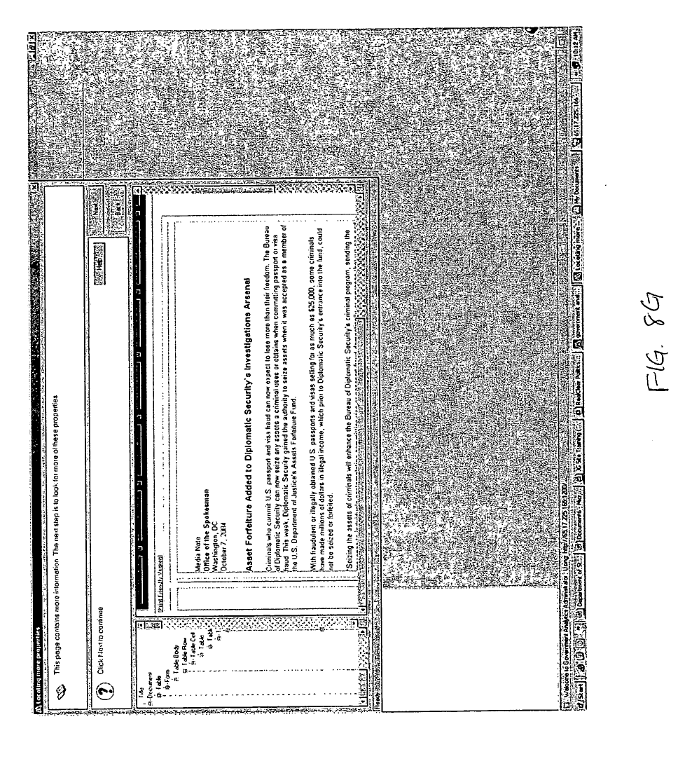

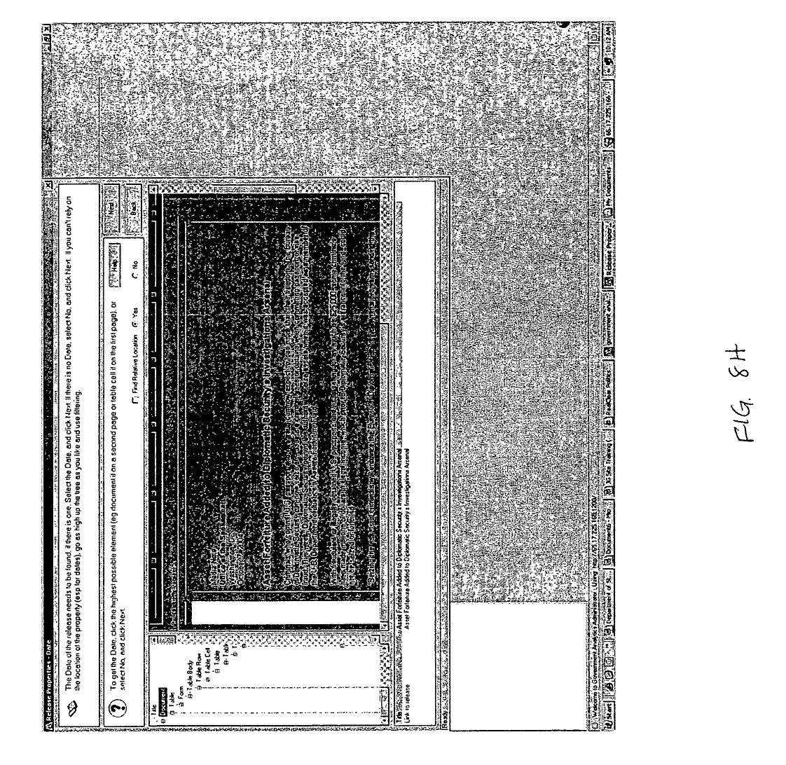

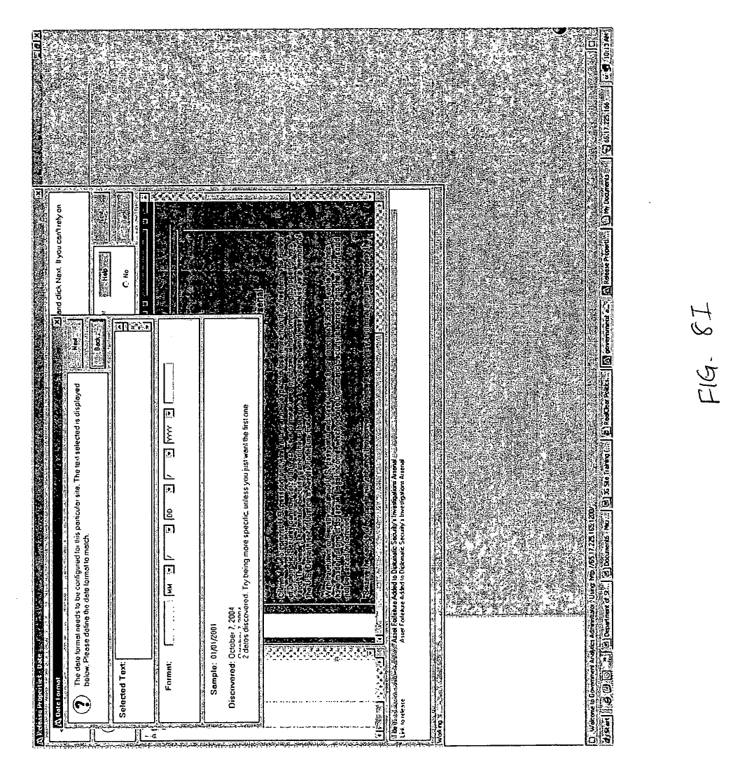

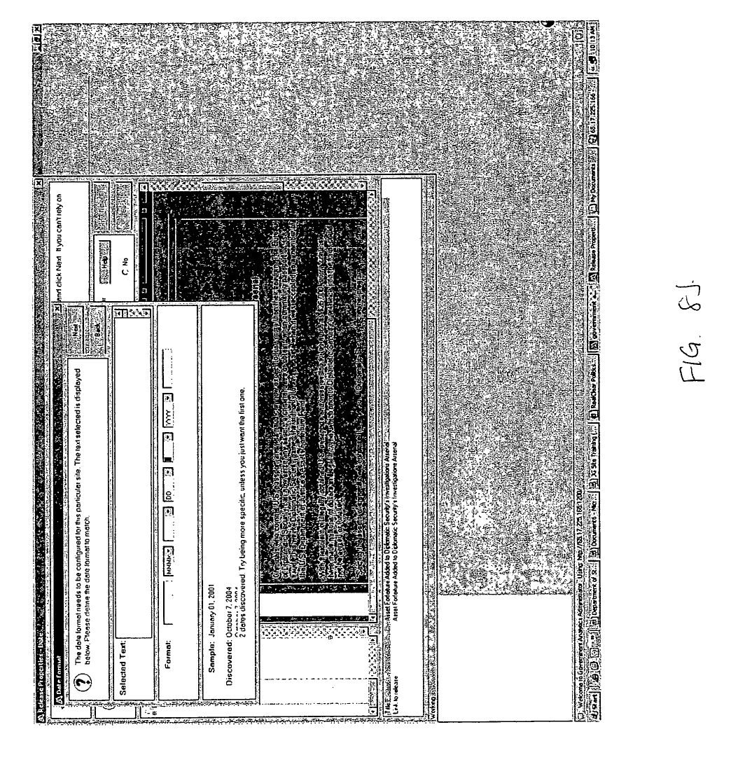

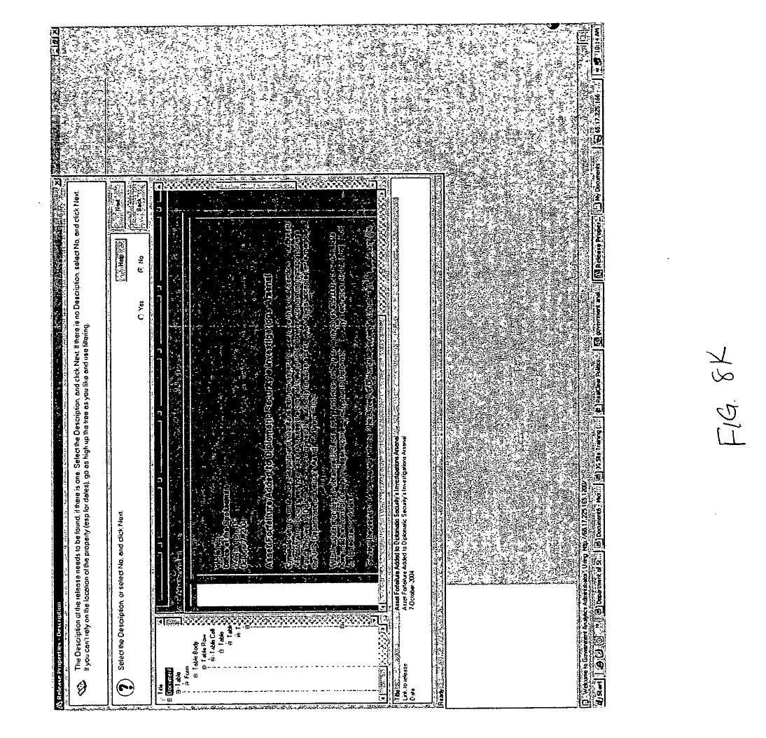

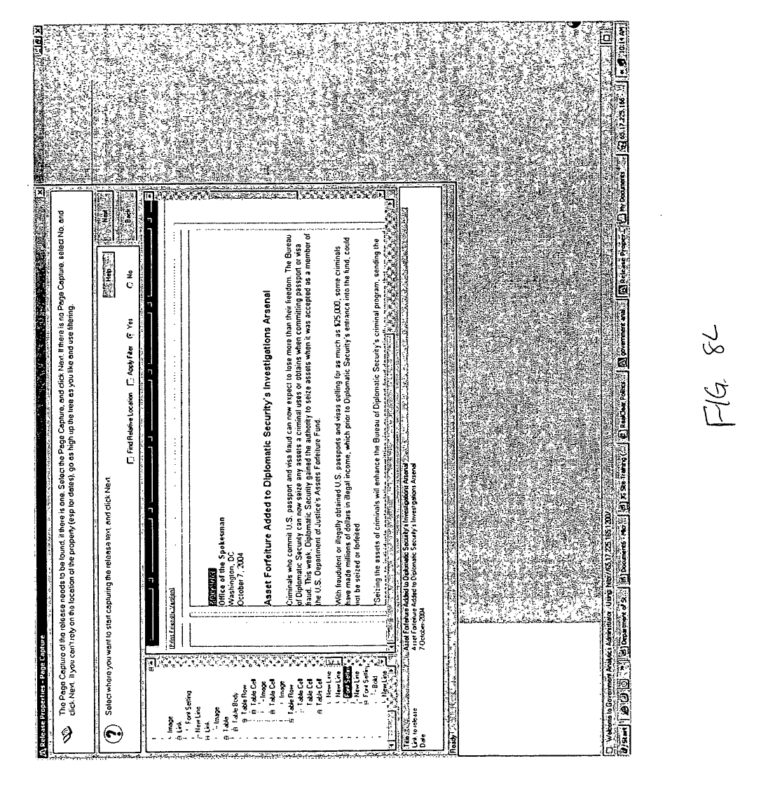

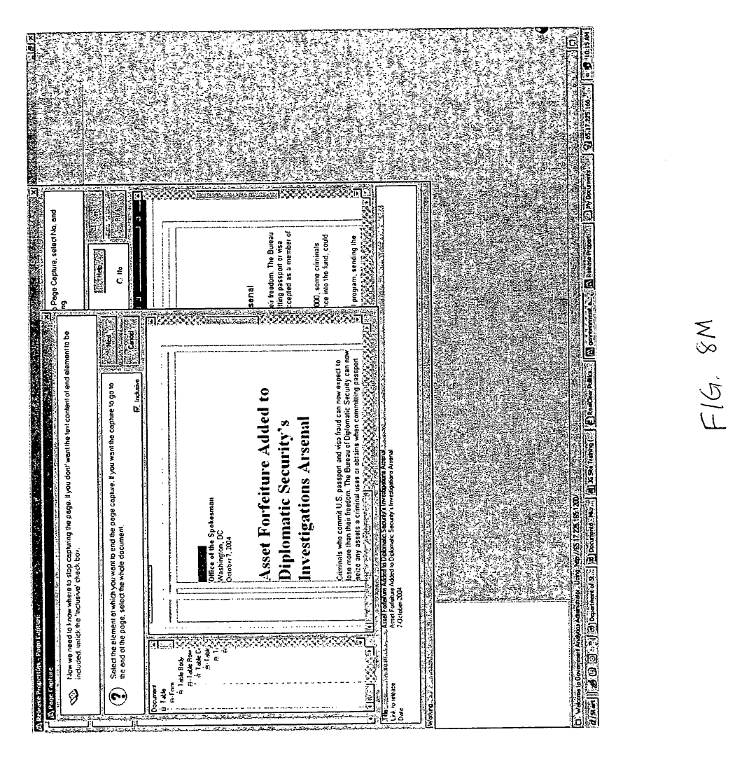

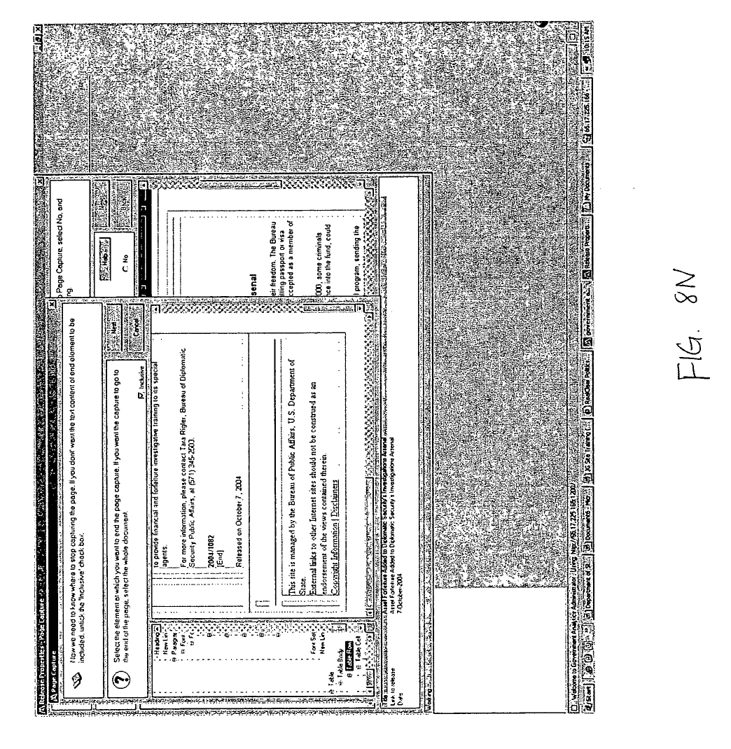

FIG. 8A illustrates an initial training dialog box 900 that may be presented to begin training a website for the retrieval of government information. Training dialog box 800 presents a URL entry field 802 for entering a starting web page. The starting web page may be a page having information with different formats. In other words, the starting web page may contain releases, links to one or more releases, a search page, and/or other pages that may enable access to releases.

Selecting an activation utility, such as, for example, “Go” button 804, enables the website associated with the entered URL to be loaded. A tree 806 may then be presented outlining the sections of the loaded website. When selecting portions of the website for training, as will be described herein, the administrator may select an element from tree 806 or select the corresponding portion of the loaded website, as depicted in FIG. 8B.

Once the starting webpage has been loaded, one or more instructions may be presented to the administrator in instruction box 808, enabling the administrator to retrieve portions of the release needed for training. Before capturing releases, the system may prompt whether spidering or filling out forms may be needed to capture the releases. These processes will be described in detail hereinafter.

If spidering or form filling is not being used, the system may prompt to select the first release on the loaded page. This may be done by highlighting the release on the page or selecting the appropriate element from HTML tree 806. Based on the selection of the first release, all releases on the loaded page may be automatically selected following the same format. If the releases have not been correctly selected, they may be manually corrected. The system may then prompt for the selection of one or more properties of the releases to facilitate the retrieval process. As indicated in FIGS. 8F-8N, such properties may include, for example, the title of the release, a link to the release, the release date, the text of the release, and/or other release properties or characteristics of the releases. Once all releases on the first page have been processed, the user may be presented with a summary of the releases, as shown in FIG. 8O.

According to some embodiments of the invention, spidering may be used to collect releases. Spidering may include the process of finding pages that include releases by following links form a starting point. Spidering may be set up by following more pages after setting up releases on the start page. In an alternative embodiment, spidering may be set up from an index page to pages with releases.

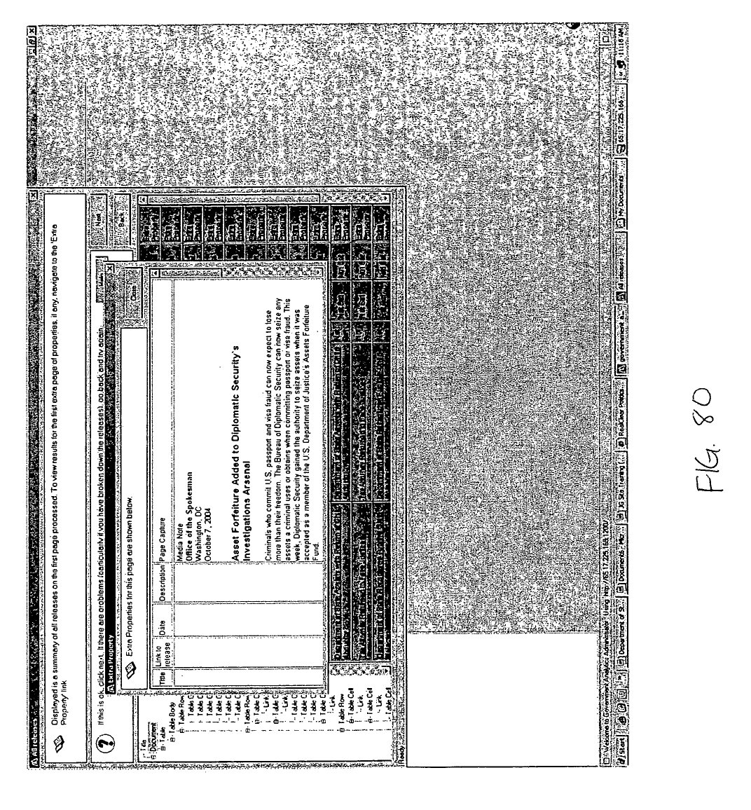

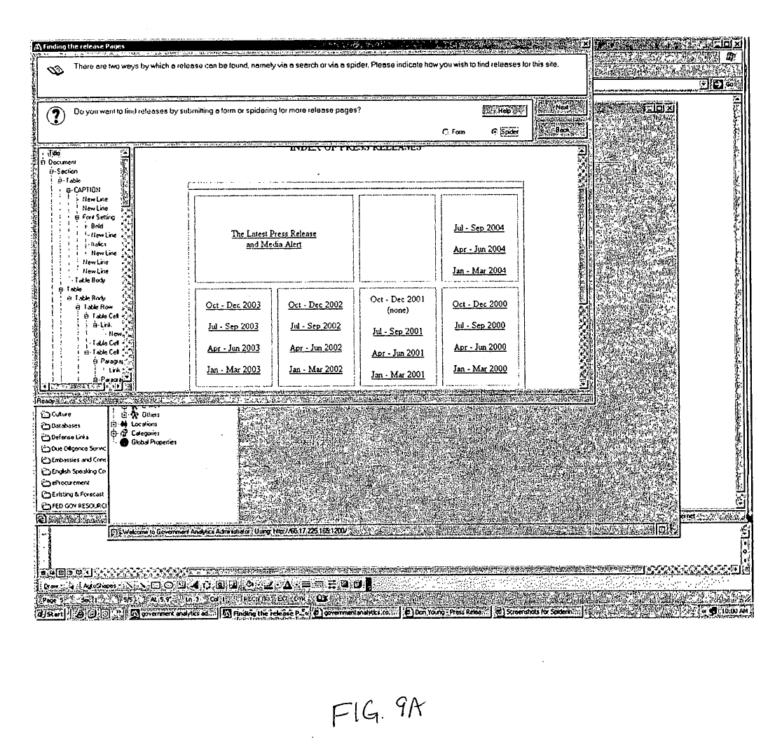

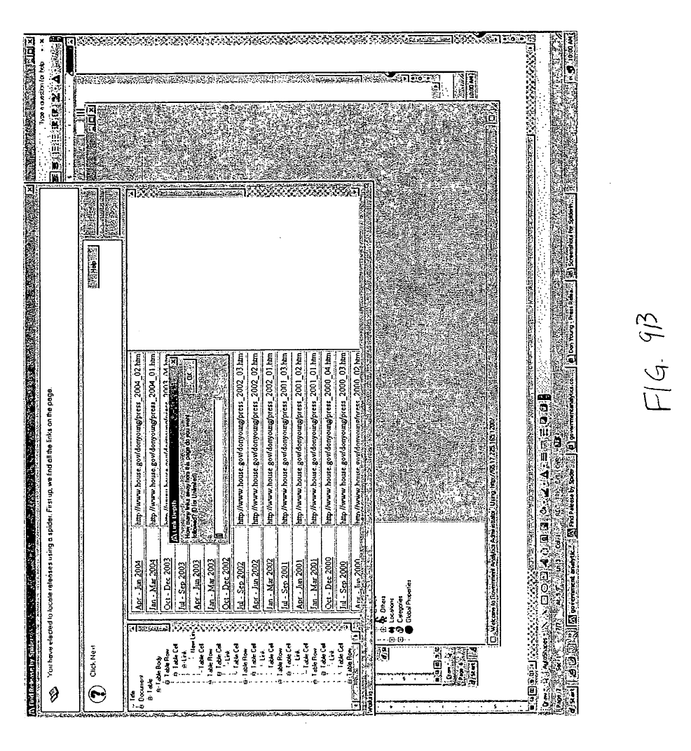

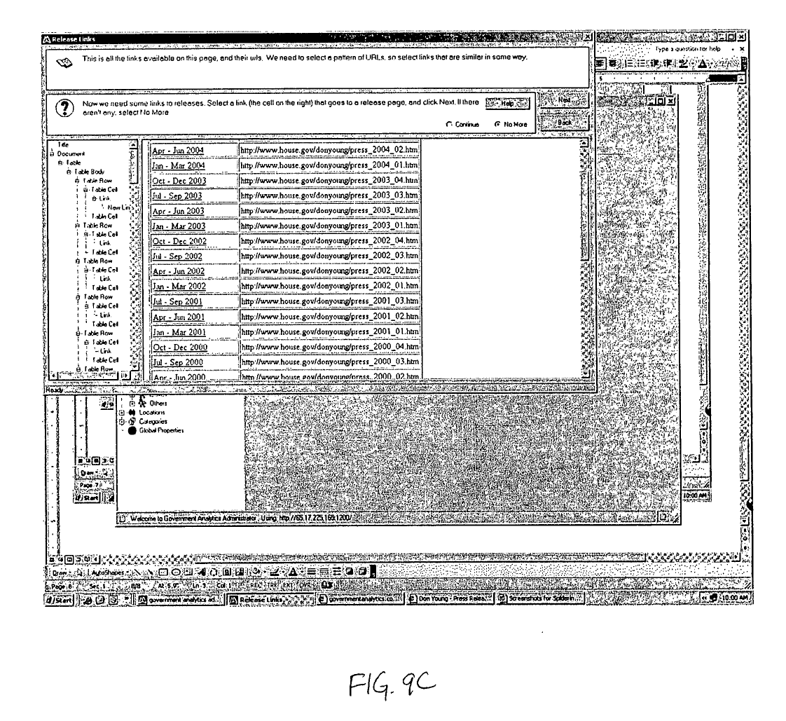

As shown in FIG. 9A, the system may prompt the user to select spidering as a means finding additional release information. One or more parameters may be configured to enable a spidering process, such as, for example, determining whether to follow links, determining what depth to follow to find release pages, defining a pattern of the URL for a page with releases on it, determining what URLs to ignore, and/or other parameters.

Once a user has decided to use spidering to find release pages, the user may be presented with a message box for entering the number of links that should be followed from the starting page, as shown in FIG. 9B. The number of links may refer to the number of mouse clicks from the starting page. A user may enter the number zero to follow an unlimited number of links. The user may next define a pattern for pages having releases. As shown in FIG. 9C, the system may request that the user access a page of release information from among the links to be spidered. The user may select a plurality of links to help define a pattern and, as indicated in FIG. 9D, the user may alter or modify the selected links.

Based on the selected links, the system locates other pages which may contain releases. The user may be presented with a list of release pages and may select one or more pages to ignore. Wild card patterns generated from the selected pattern links may be edited.

According to some embodiments, the system may also find release information by completing forms on websites, mimicking what a user would do. This enable release information to be found that may not be available using spidering. One or more types of forms may be used, such as, a simple form, a list form, and/or other forms. For example, a simple form may mimic the search carried out on a screen, while a list form may iterate through a list of options such as may be found in a drop down menu. FIG. 10 illustrates a form selection page 1000. Form selection page 1000 may present the user with an option to select the type of form to be completed.

If the form to be completed is a simple form, a set of criteria may be sent once, and a list of results may be provided. For list forms, a list in the form is selected, and every item in the list may be submitted one by one. Each item may lead to a single release that is processed, or may, in alternative embodiments, lead to a page with a list of releases to processed. By way of example, FIGS. 11-13 illustrate a series of screens a user may be presented with to complete list form. As illustrated in FIG. 11, the user may be asked to select the form list. The user may select the list by clicking near it and selecting the appropriate HTML tag in the HTML tree illustrated to the left.

As illustrated in FIGS. 12 and 13, the user may then submit the list by selecting a “form input area” tag from the HTML tree. The user may submit the list by clicking the “form input area” tag and holding down the CTRL key. A page including releases may then be presented. Sites may include a button that may be selected to move to additional pages having releases, rather than following links to reach these pages. As illustrated in FIG. 14, a user may be asked to select the “Next” button. As illustrated in FIG. 15, the “next” button may not be the same for each page. In FIG. 14, the user as selected the “Page 2” button as the next button. The system attempts to locate the next button in subsequent pages, but may incorrectly select a button, as illustrated in FIG. 15. The user may then select the correct button. It will be appreciated that the system may employ a setup function or utility, such as a setup wizard, to train the website.

Once the system has completed its process of locating releases, additional properties may be added or confirmed. For example, FIG. 16 illustrates a message box 1600 for setting additional properties. As illustrated, the user may classify a website as belonging to a particular type of organization, such as, for example, an intergovernmental agency. The user may also select the type of resources that are available on the website and set options for when the website should be harvested. Harvesting options may determine whether the website is harvested once, continuously, or whether the website's resources are to be available on the system website.

Administrative users may manually adjust properties associated with a particular website by selecting the website from sites tree. FIG. 17 illustrates a website properties interface 1700. Website properties interface 1700 may enable the user to rename the website, retrain the website by running the setup wizard again, clone the website, by copying the website setup to a new website, view harvested releases for the website, delete the website and/or its harvested releases, change the organization or resource type, and/or other administrative tasks. Display properties and/or collection properties may also be edited. The user may also change the harvesting schedule, as described above.

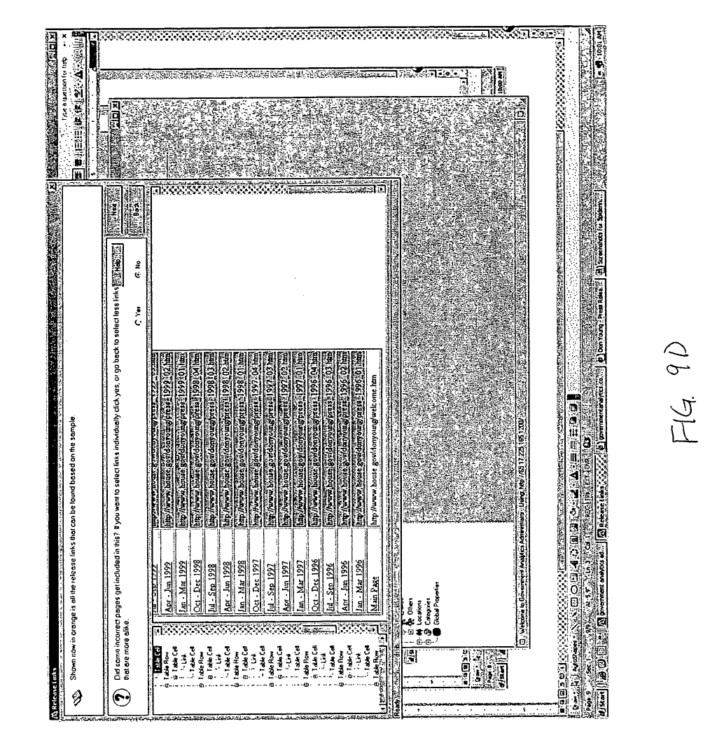

A categories menu may be used to define categories by which releases may be found on the system website. Categories may be set as a default for all releases on a website, or may be automatically generated by matching terms in the release text. FIG. 18 illustrated a category selection interface 1800. A user may add new categories and/or modify rules for an existing category. A root category may have one or more children categories. Children categories may be added by selecting a root category and selecting a “Manage Children” tab, as illustrated in FIG. 18. Here, the user may also delete a category. Rules may be used for automatically assigning releases to one or more categories. The category rule may be a term or phrase, and a release may match one of the rules and be included in category if matches the category and its parents.

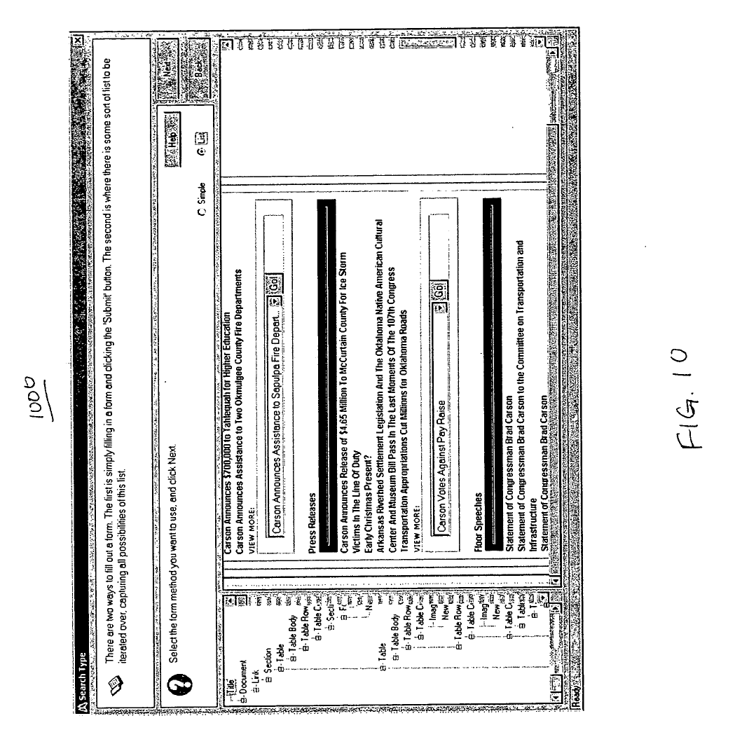

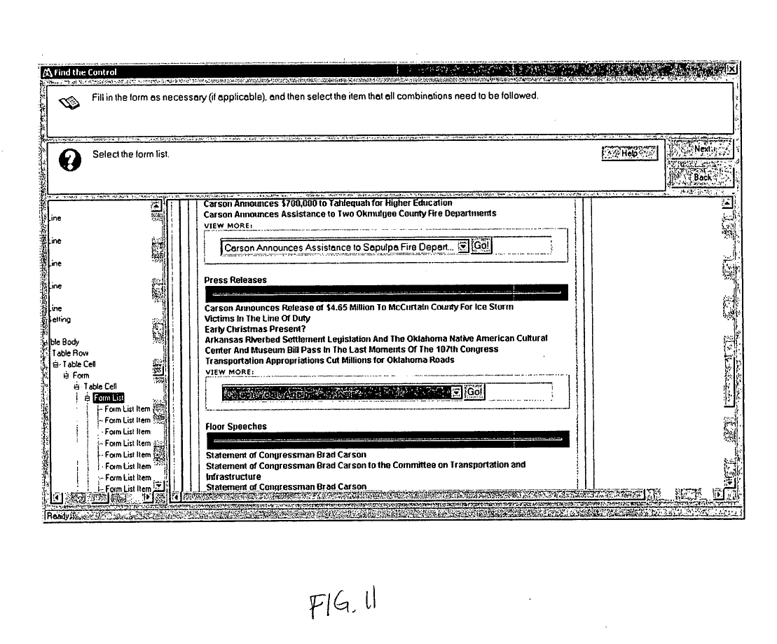

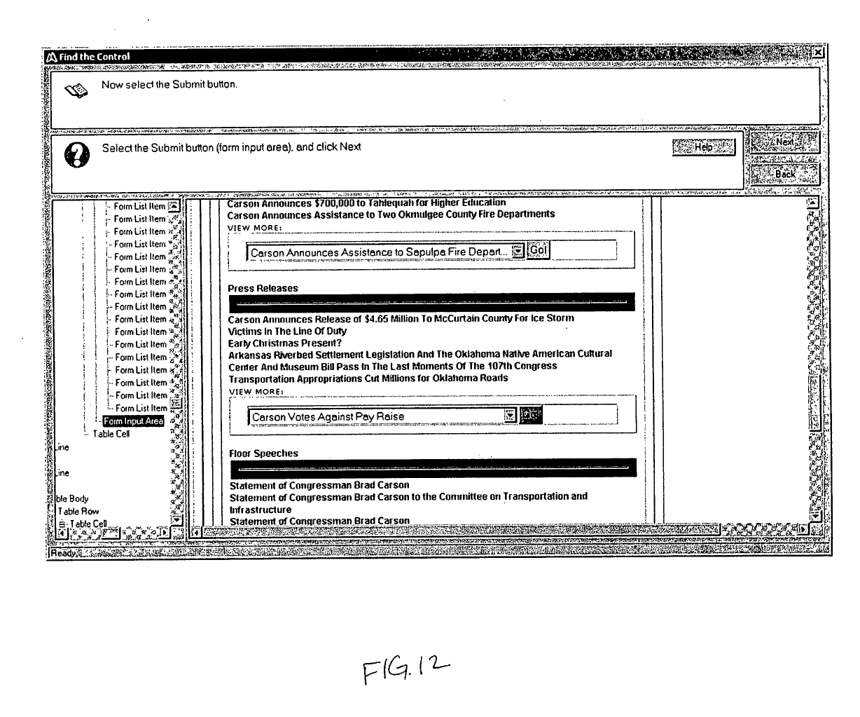

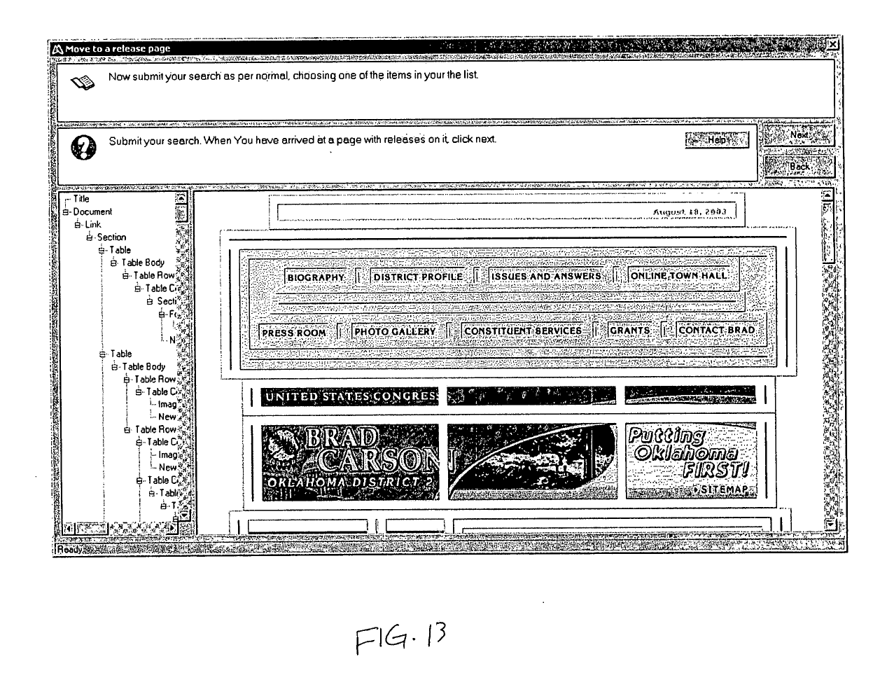

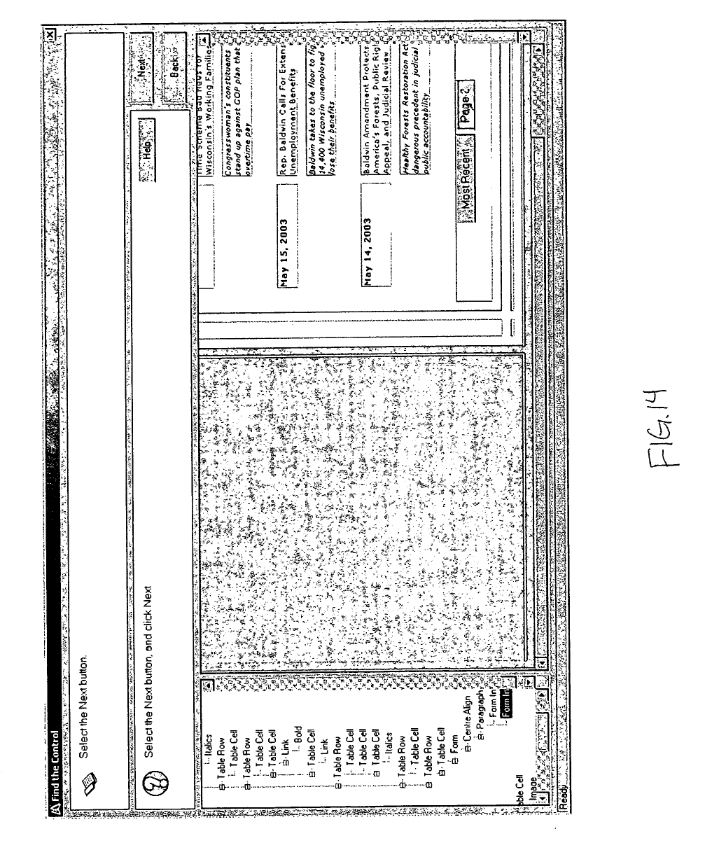

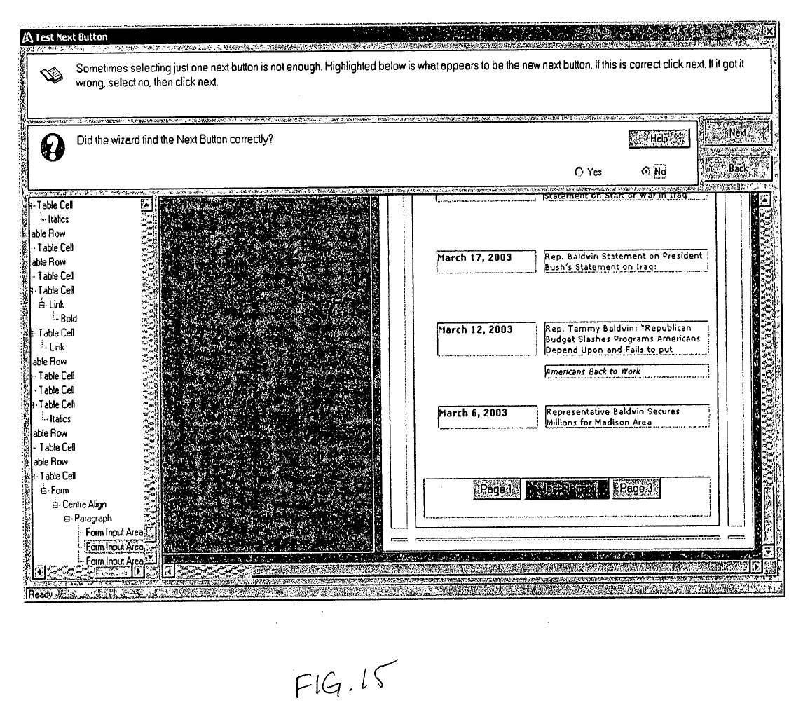

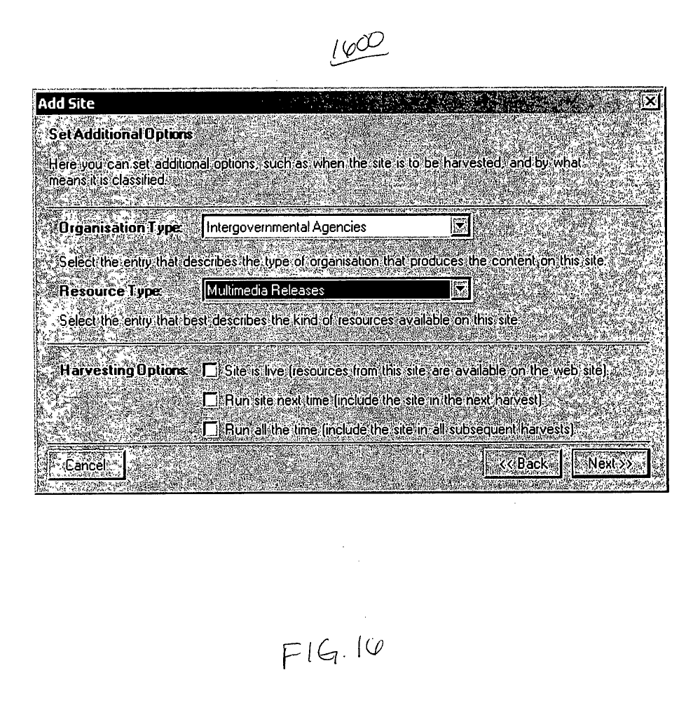

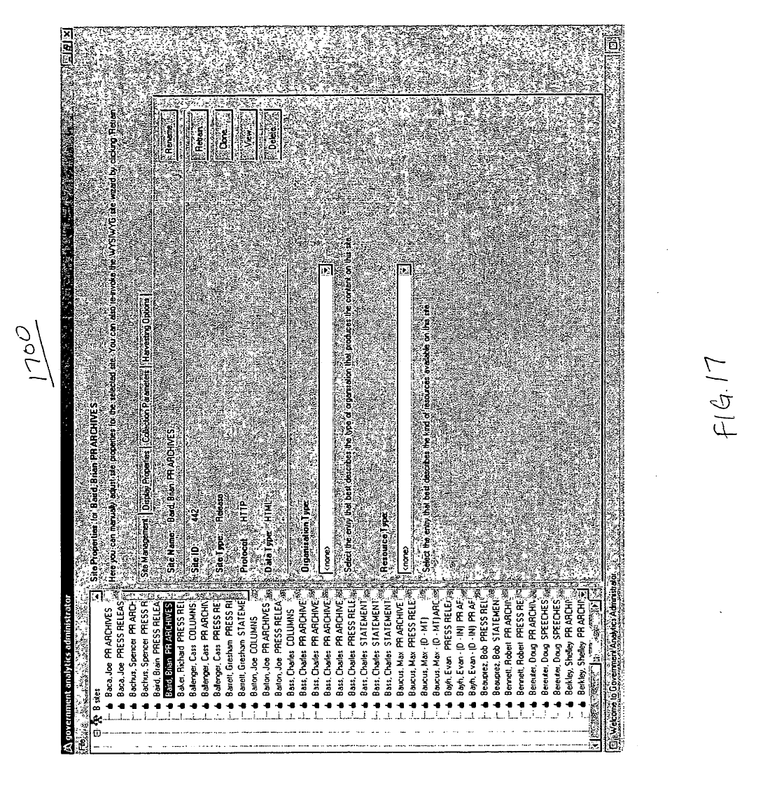

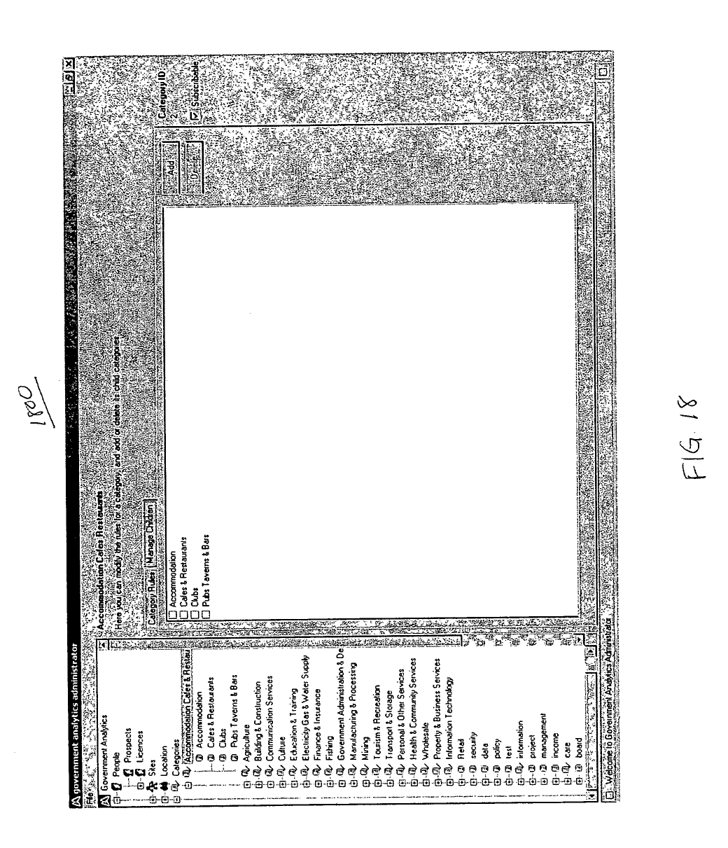

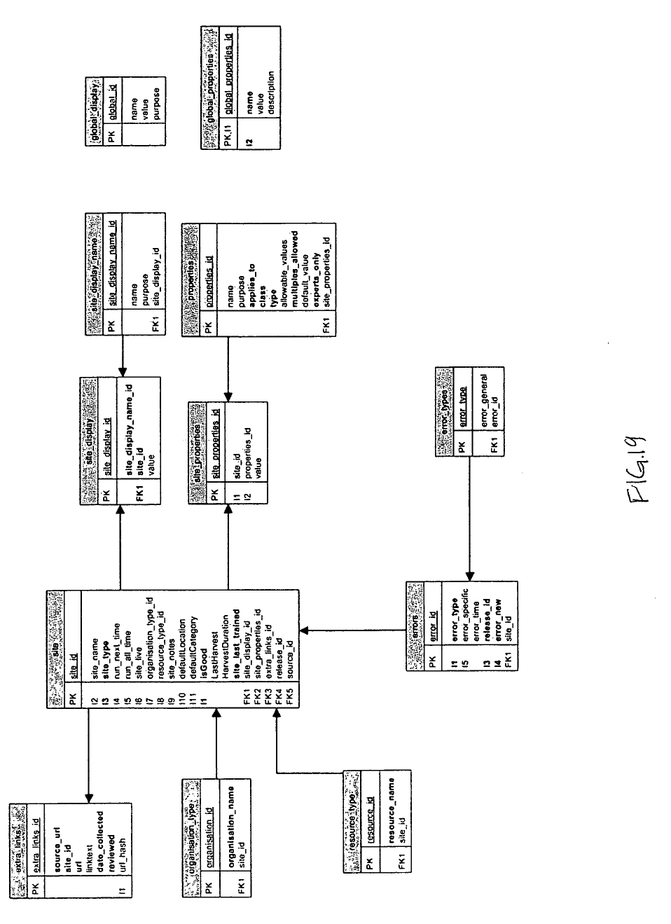

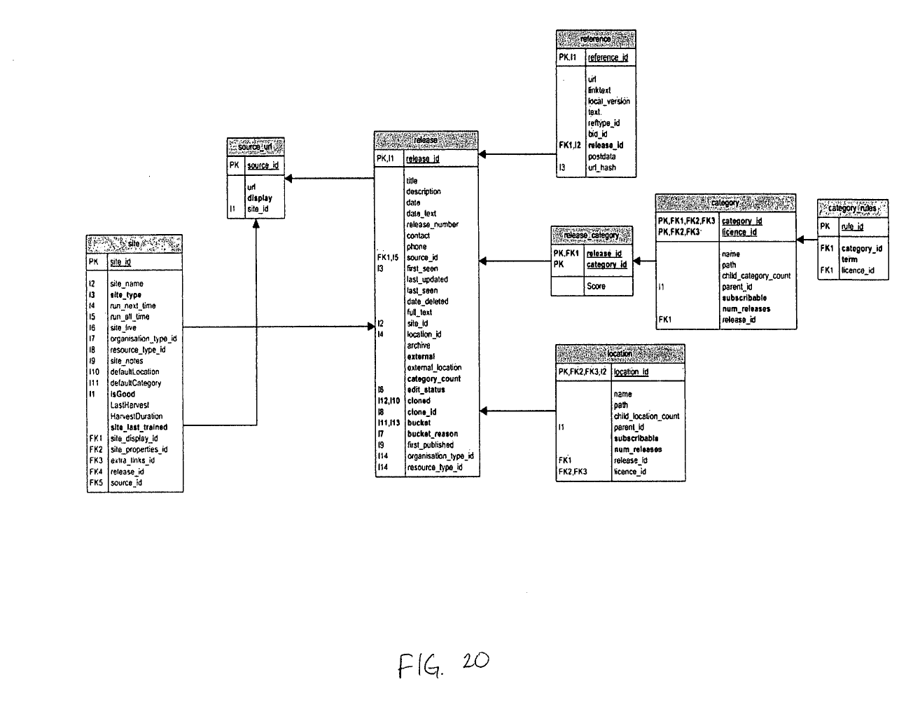

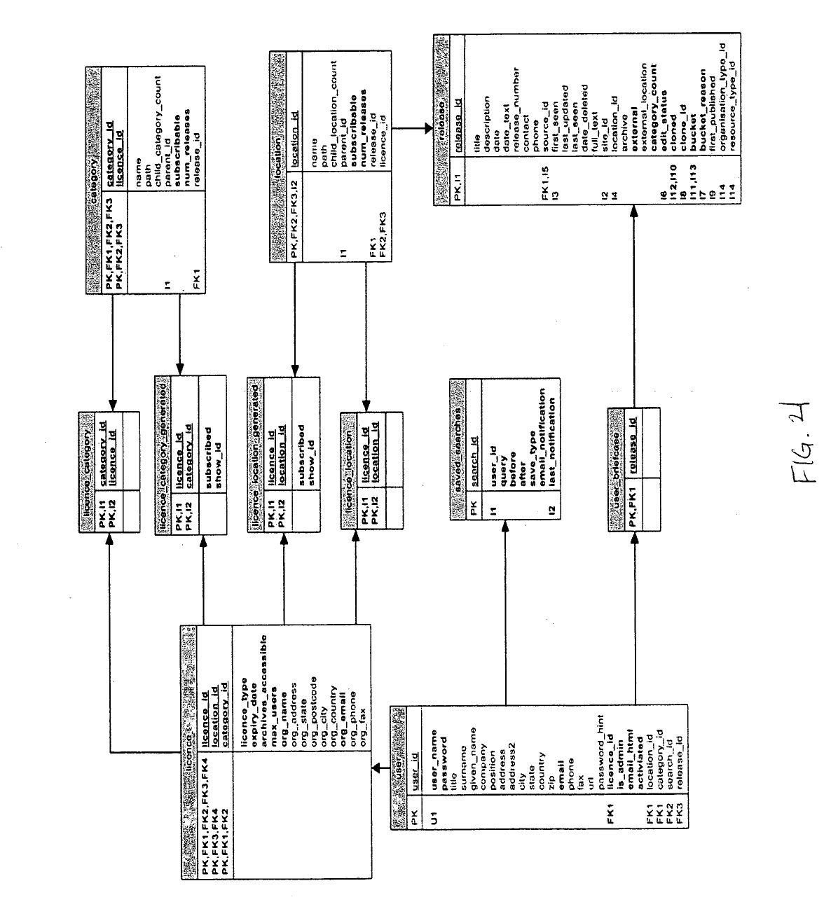

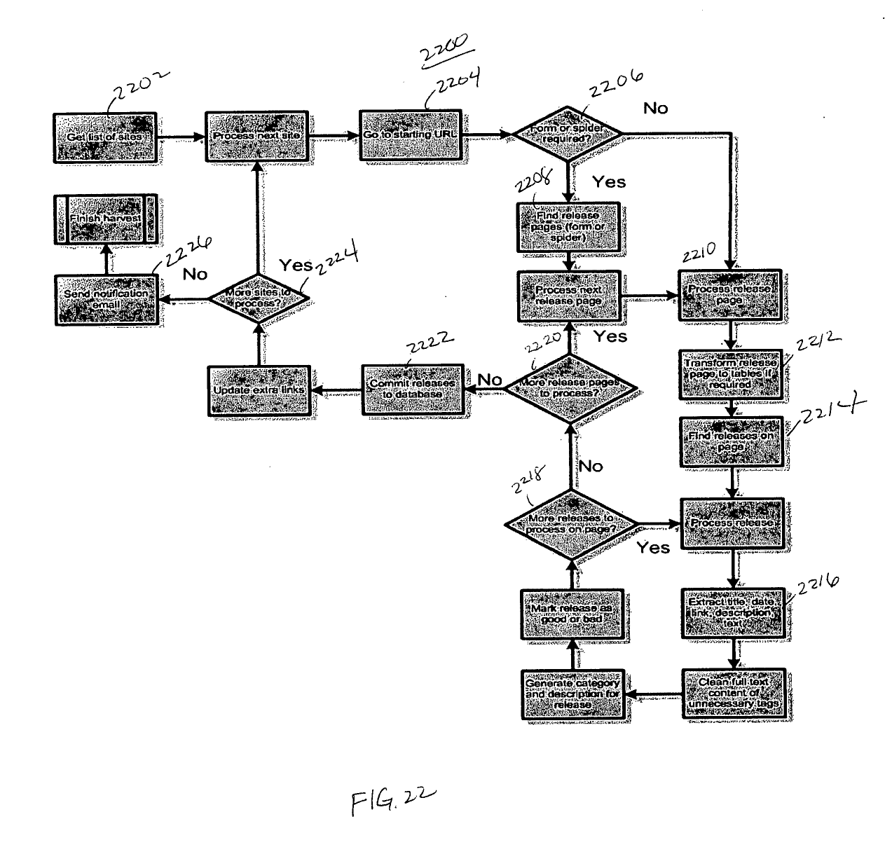

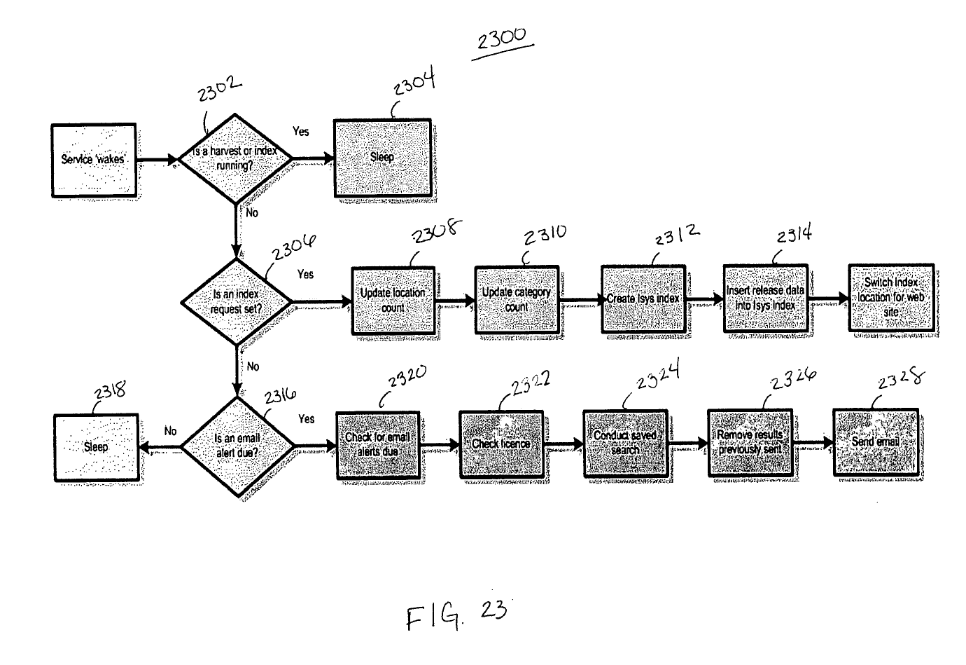

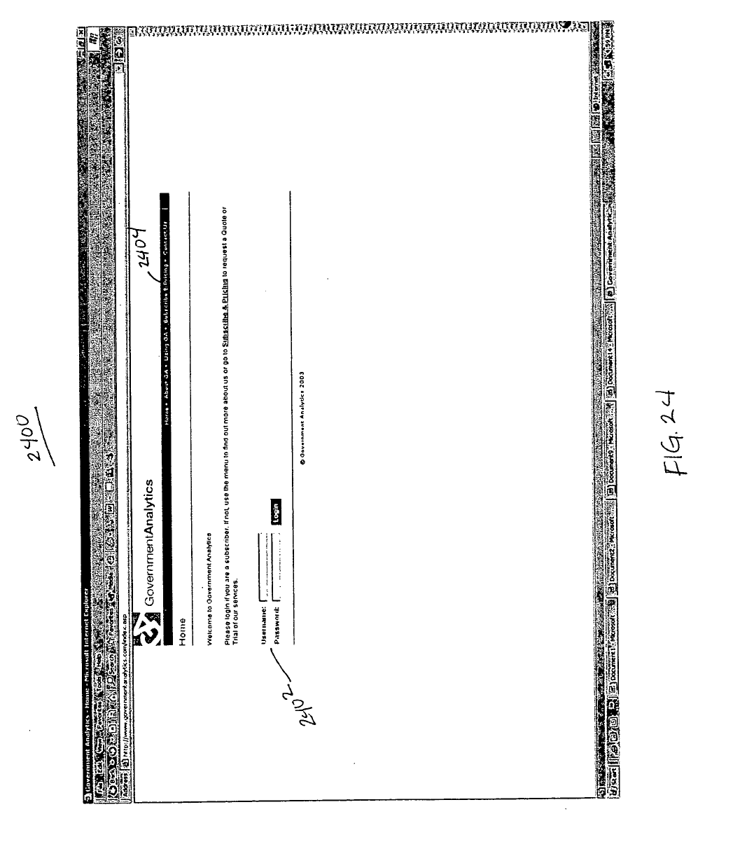

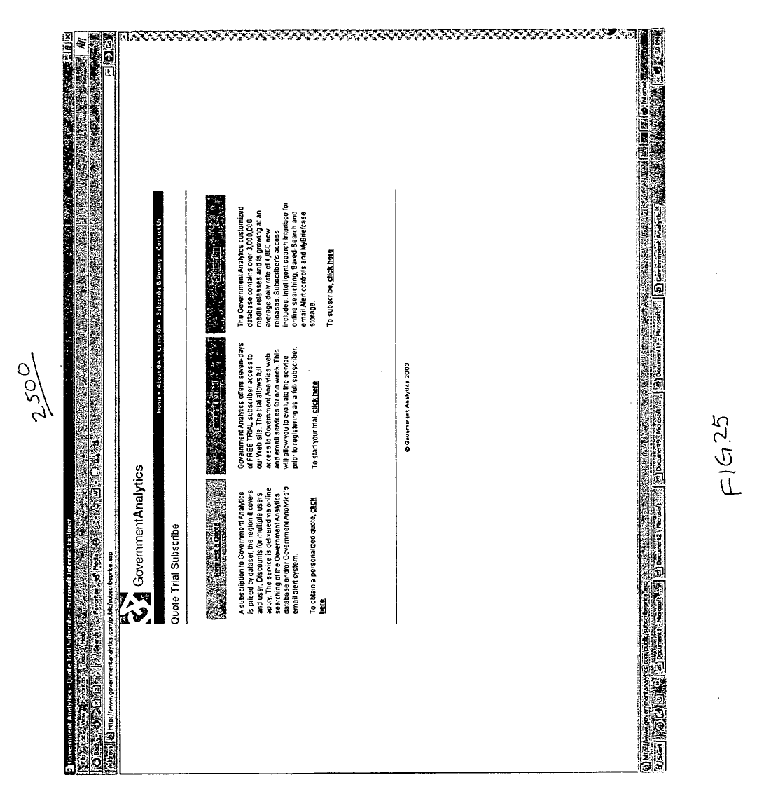

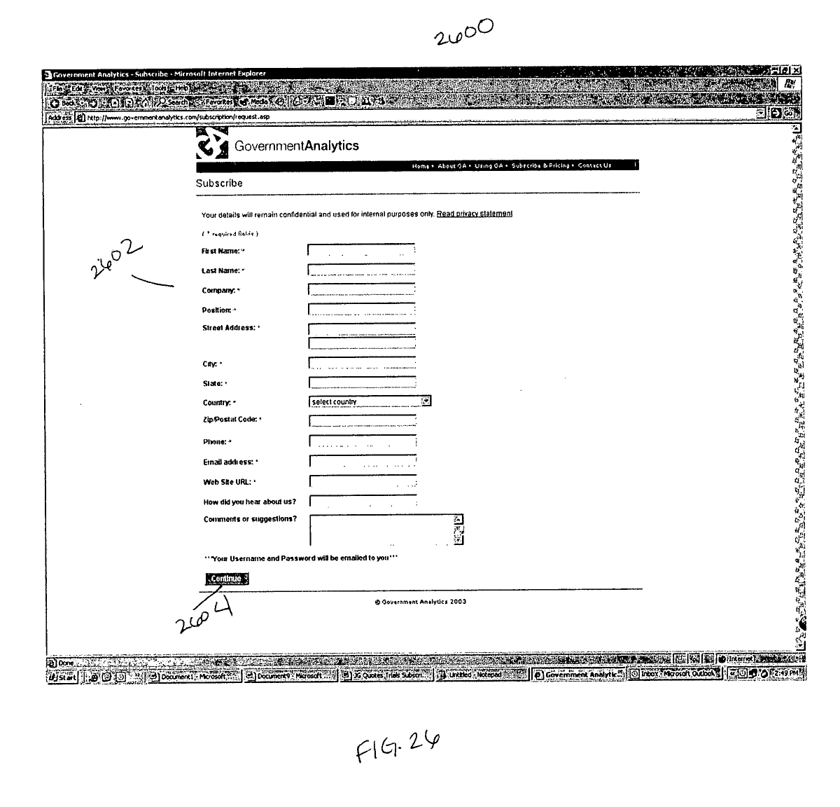

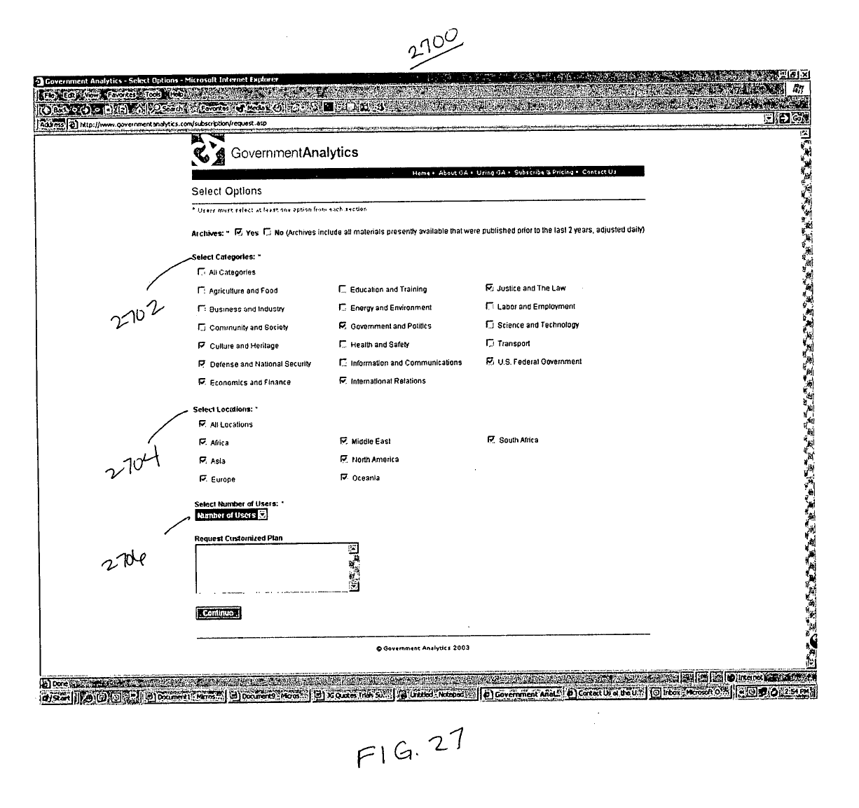

FIG. 19 illustrates, by way of example, a data structure relating websites, site properties, and global properties. FIG. 20 illustrate, by way of example, a data structure relating releases, locations, and categories. FIG. 21 illustrates, by way of example, a data structure relating users and licenses.

Once rules for collecting data have been created, data may be retrieved at scheduled times by web retrieval module 122. FIG. 22 illustrates process 2200 which may be performed by web retrieval sub-module 122 for collecting data from one or more websites. As illustrated at operation 2202, a list of websites wherein data collection should be performed may be retrieved. In some embodiments, the list may be retrieved from administrator module 106. It will be appreciated that other methods of retrieving the list may be provided. At operation 2204, the starting URL of the first website in the list may be accessed. A check may then be performed to determine whether a form must be completed or whether a spidering process must be used to process the website, as illustrated at operation 2206. If required, releases are located using forms or spidering, as illustrated at operation 2208.

At operation 2210, a release page is processed. A release page may include one or more releases located at a website. Processing a release page may include determining the format of the page and the releases on the page based on rules, as illustrated at operation 2212. At operation 2214, one or more releases are located on the release page and processed. Processing releases will be described in detail hereinafter. At operation 2216, properties relevant to the one or more releases are extracted. Once a first release has been processed, checks may be made to determine if more releases or release pages need to be processed, as illustrated at operations 2218 and 2220. If additional releases are pages are to be processed, control is returned to the appropriate processing module, as illustrated.

Once all releases for a particular website have been processed, the extracted releases may be sent to a database for storage, as illustrated at operation 2222. A check may then be performed to determine if there are additional sites to be processed, as illustrated at operation 2224. If there are no additional sites to be processed, an email notification may be sent to one or more users informing the users that new releases have been added, as illustrated at operation 2226.

FIG. 23 illustrates process 2300 for creating or updating an index, according to an embodiment of the invention. At operation 2302, a check may be performed to determine whether a data collection process is in progress. If so, the indexing sub-module 124 may go into a sleep mode while the currently running processes complete, as illustrated at operation 2304. If no harvest or index process is currently running, a check may be performed to determine whether an index creation has been requested, as illustrated at operation 2306. If an index is required, the location count and category count for corresponding to a location and category for the entry to be indexed is updated, as illustrated at operations 2308 and 2310. The index may then be created and the release data may be inserted into the index, as illustrated at operations 2312 and 2314.

At operation 2316, a test may be performed to determine whether an email alert is due. An administrator may configure email updates to be provided to one or more end users. Users may also save executed searches to be performed again later. If the user has saved a search, the search is re-executed before the email update is provided, and only those results not previously obtained are presented, via email, to the user, as illustrated at operations 2320-2328. As illustrated at operation 2018, the indexer may go into a sleep mode if no email alerts are due.

One or more users may access system 100 via a user interface, such as user interface 2400, illustrated in FIG. 24. User interface 2400 may be accessed via a website address and may present an initial login option 2402. If a user is not yet registered to use the system, the user may select an option to register. For example, the user may select “Subscribe & Pricing” hyperlink 2404. In response to a user selection hyperlink 2404, the user may be presented with user interface 2500, as illustrated in FIG. 25. User interface 2200 may provide the user with options of requesting a quote, requesting a trial membership, or obtaining a full subscription to the system.

After a user has chosen a desired option from user interface 2500, the user may be presented with an electronic form 2600, as illustrated in FIG. 26. Electronic form 2600 may present a plurality of personal information fields 2602 for obtaining information needed to complete a quote, trial, or subscription. Upon completion of electronic form 2600, the user may select a “Continue” button 2604, and may be presented with an options screen 2700, as illustrated in FIG. 24. Options screen 2700 may include options to select one or more categories 2702 or locations 2704 from which the user would be interested in retrieving information. A subscription may be tied to one or more users, and the subscription cost may vary according to the number of users who will be accessing the subscription. Thus, according to some embodiments of the invention, a “Number of Users” menu 2706 may be provided on options screen 2700 enabling a user to input the number of users expected to access the system.

Once a user has completed registration and has logged on to the system, the user may be presented with a main search/browse page 2800, as illustrated in FIG. 28. Search/browse page 2800 may include a search section 2802 for entering search criteria to be used in finding desired documents. Search section 2802 may include a keyword entry field 2804 and one or more filters for restricting the search.

For example, filters may include a date range filter 2806, a categories filter 2808, a locations filter 2810, a media release filter 2812, and/or other filters. The user may enter one or more keywords in keyword entry field 2804. If no filter values are entered, a search may be performed of all harvested documents based on the entered keywords. One or more buttons may be presented, such as, for example, a search button 2814 for executing the search, a reset button 2816 for clearing the entered search criteria, and a save search button 2818. When the save search button 2818 is selected, the search criteria is stored and a saved search list 2820 may be presented, listing each saved search. This enables a user to efficiently re-execute a search.

A browse section 2822 may be provided enabling a user to browse all harvested documents by category or region. Sub-categories may be provided enabling the user to further narrow the browsing. Search/browse page 2800 may also include options to browse by one or more categories, sub-categories, regions, and/other browsing options.

Results obtained from performing a search and/or browse operation may be presented in results summary 2900, as illustrated in FIG. 29A. Results summary 2900 may include a list 2902 of one or more items matching the entered query. Each item in list 2902 may include a date the item was published as well as a relevance metric. Results may be sorted by date or relevance. An option 2904 may be provided for searching within a list of results, in other words, “searching within a search.” This enables a user to further narrow a search by restricting the search to only the retrieved items. As depicted in FIG. 29B, selecting an item from list 2902 may retrieve the full text of the item. The web source of the item may also be presented.

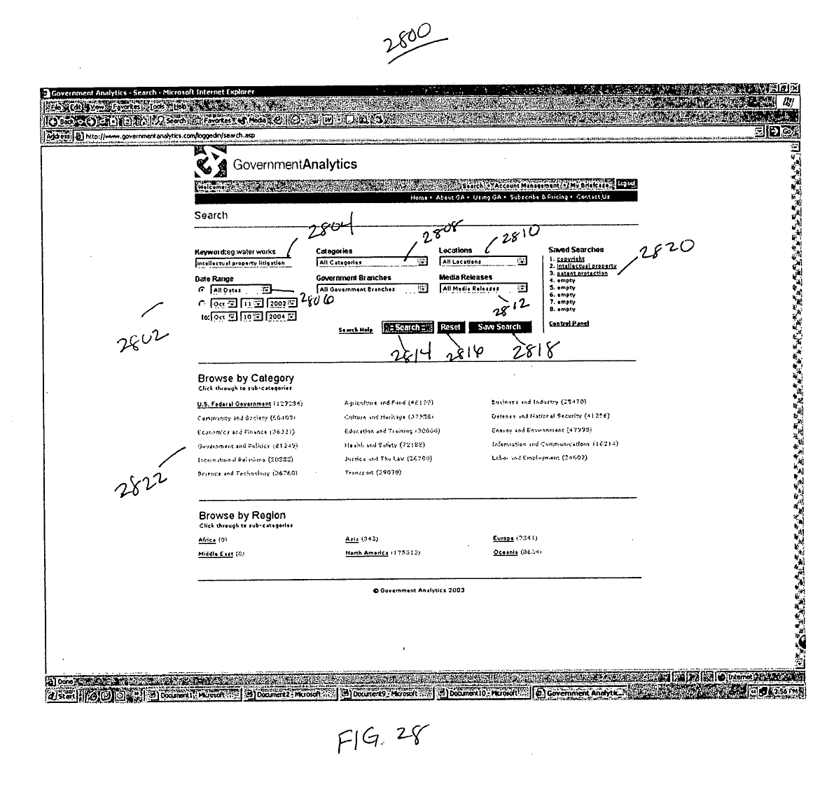

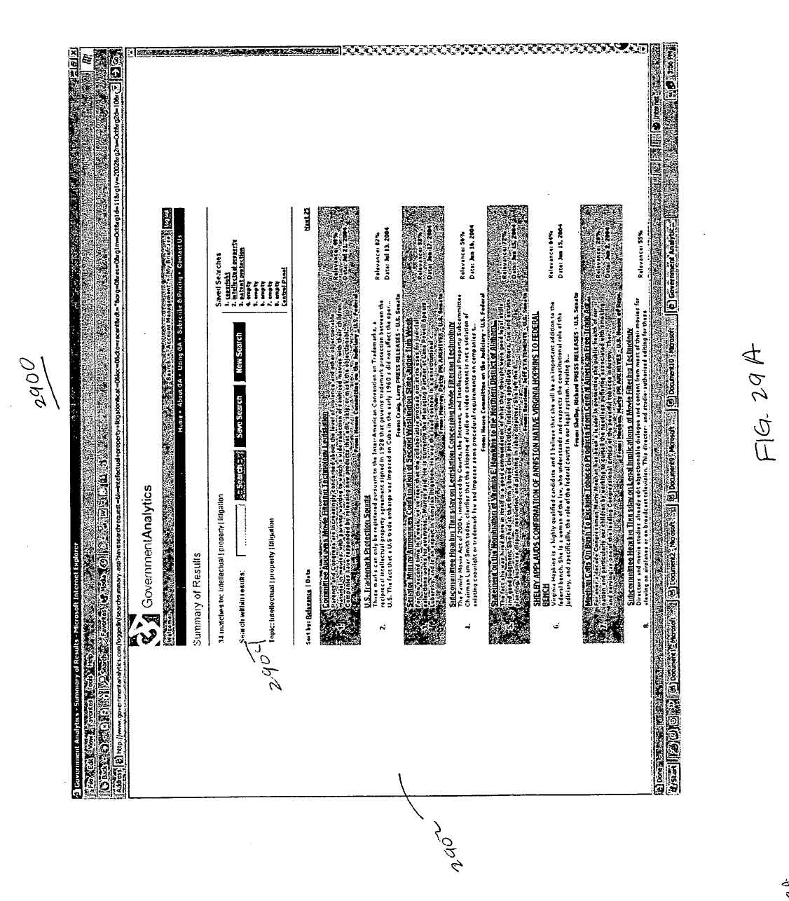

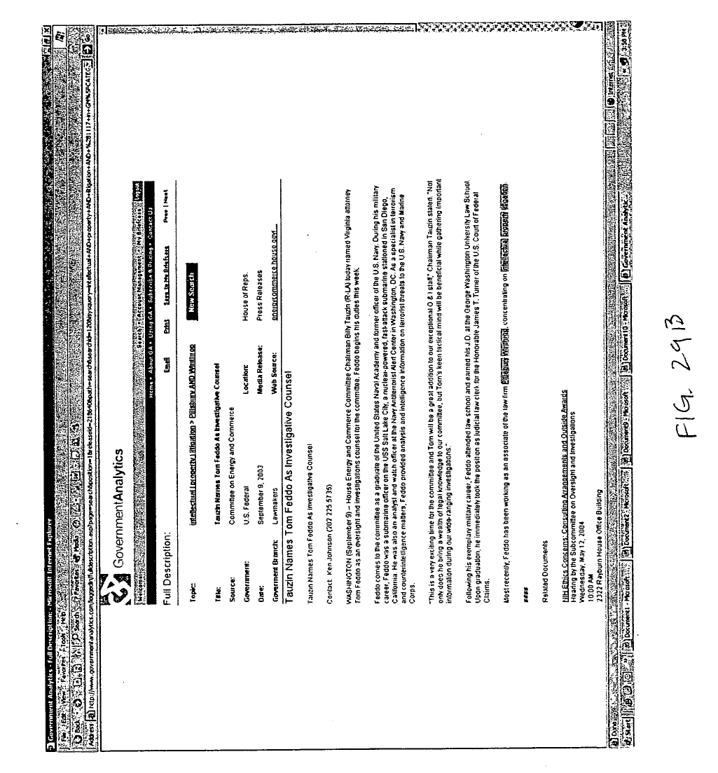

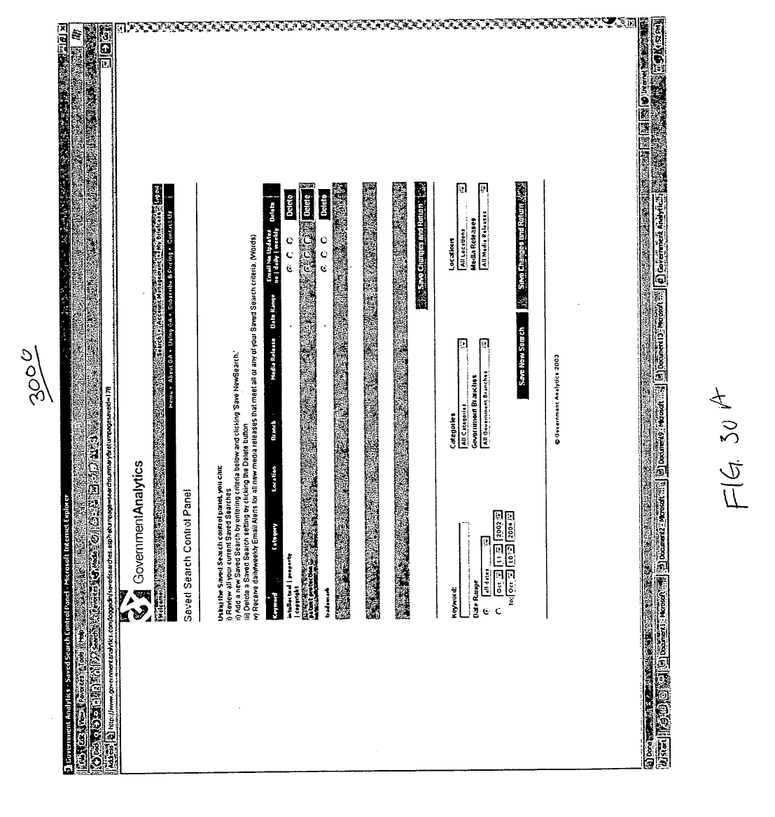

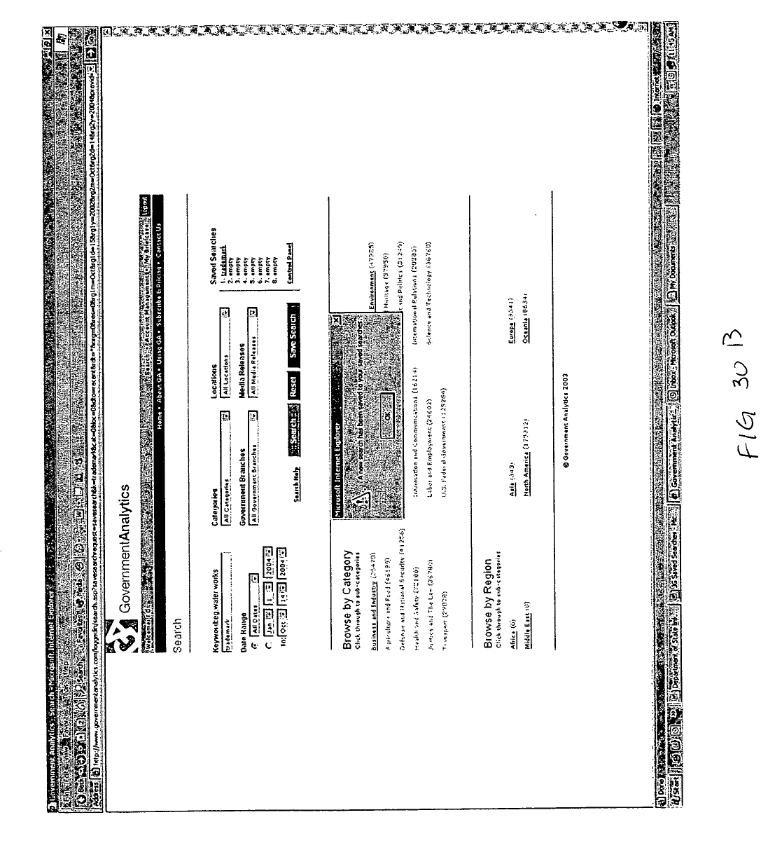

The searches may be saved for future use and may be managed using saved search control panel 3000, as illustrated in FIG. 30A. As shown in FIGS. 30A, 30B, control panel 3000 may include a list of each saved search, options to email updates to each saved search, as well as an option to delete a saved search. Control panel 3000 may also include an option to create and save a new search by entering more keywords and selecting one or more filters. As indicated in FIGS. 30B, 30C, the saved searches may be provided in a listing of hypertext links and a user can then access a summary of search results by selecting the hypertext link entry corresponding to the desired search.

In addition to saving searches, the system and method of the present invention may provide a mechanism for saving individual items retrieved from the system. As illustrated in FIG. 31A, a user may access briefcase 3100. Briefcase 3100 may include links 3102 to each saved item. In one embodiment, the search may be saved to briefcase 3100 after a full description of the desired release information by selecting the “save to my briefcase option” 3104, as indicated in FIG. 31B.

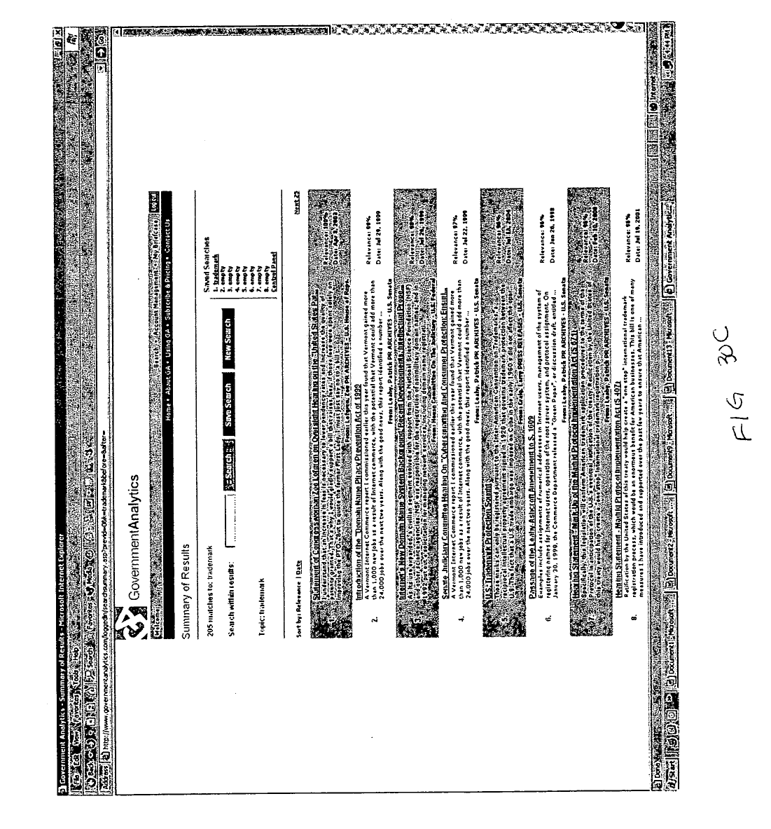

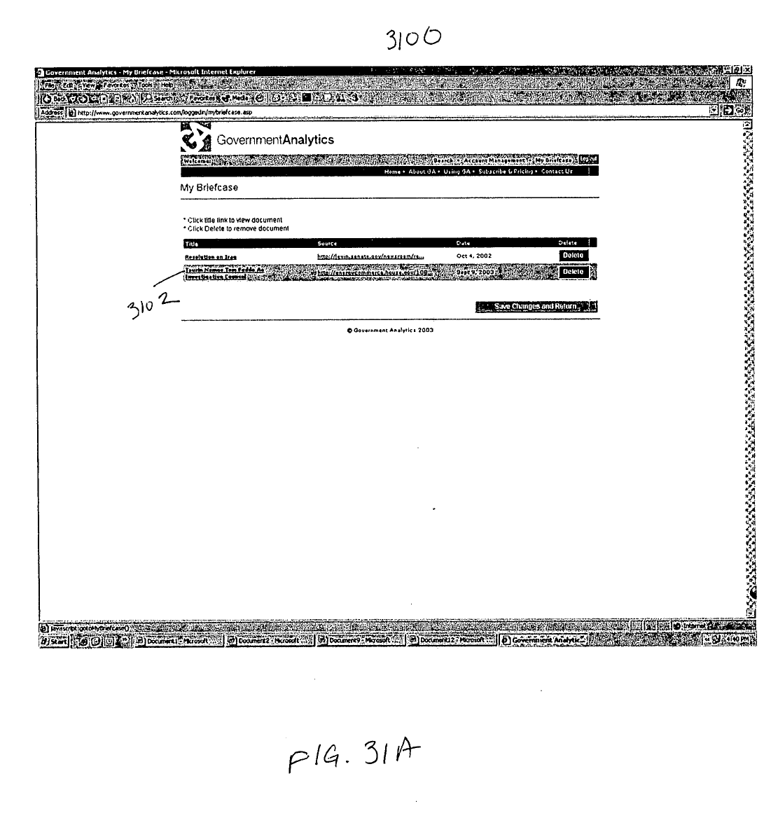

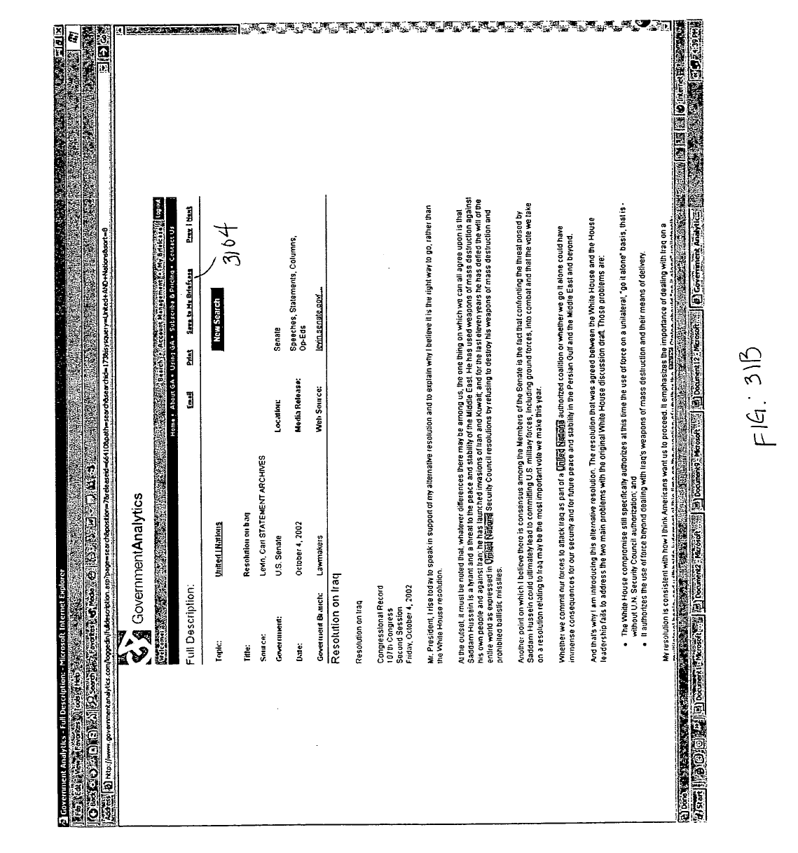

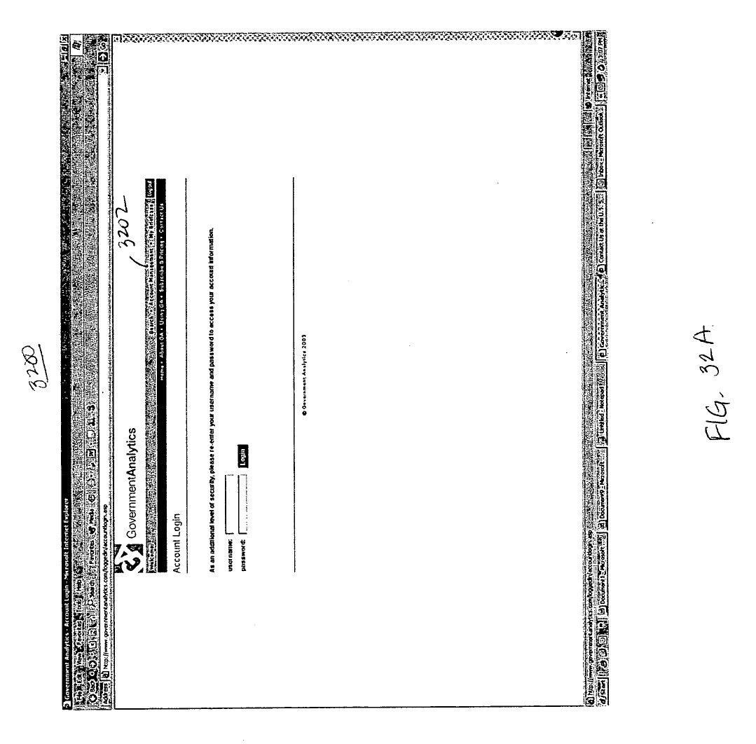

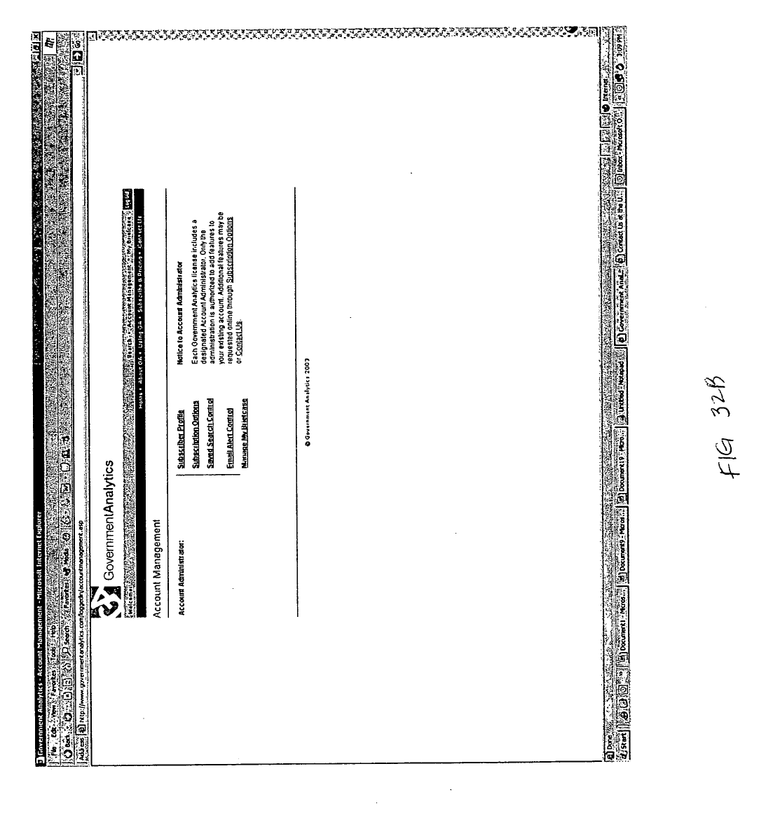

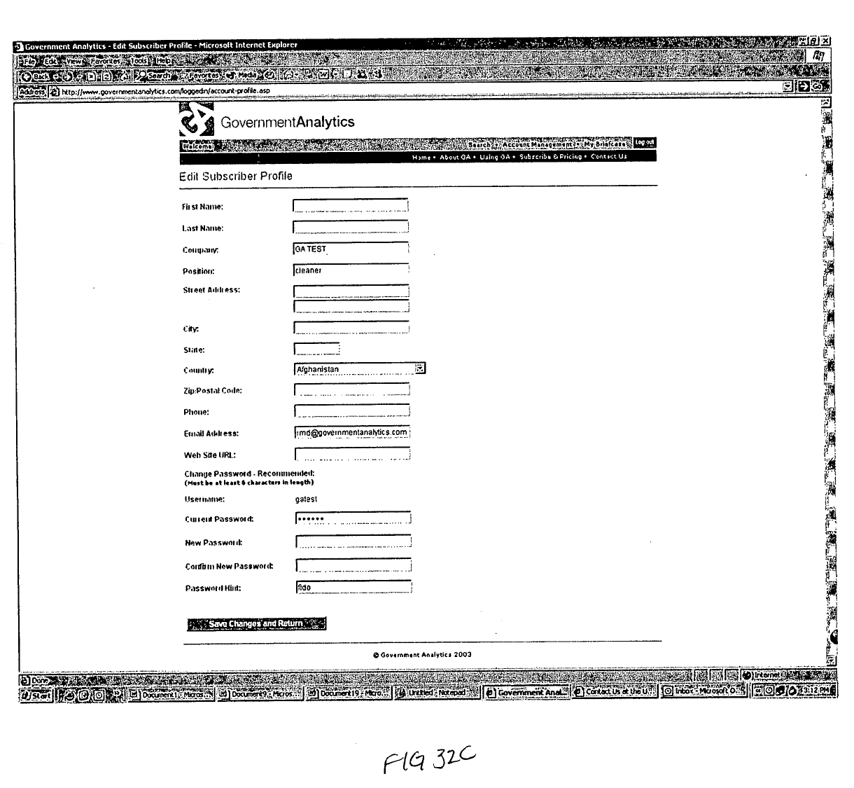

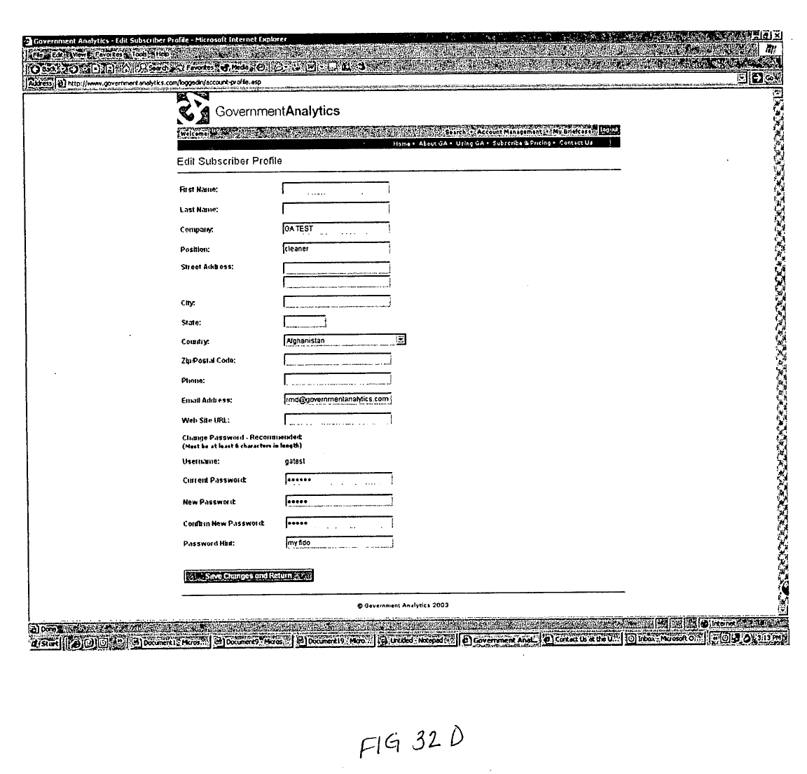

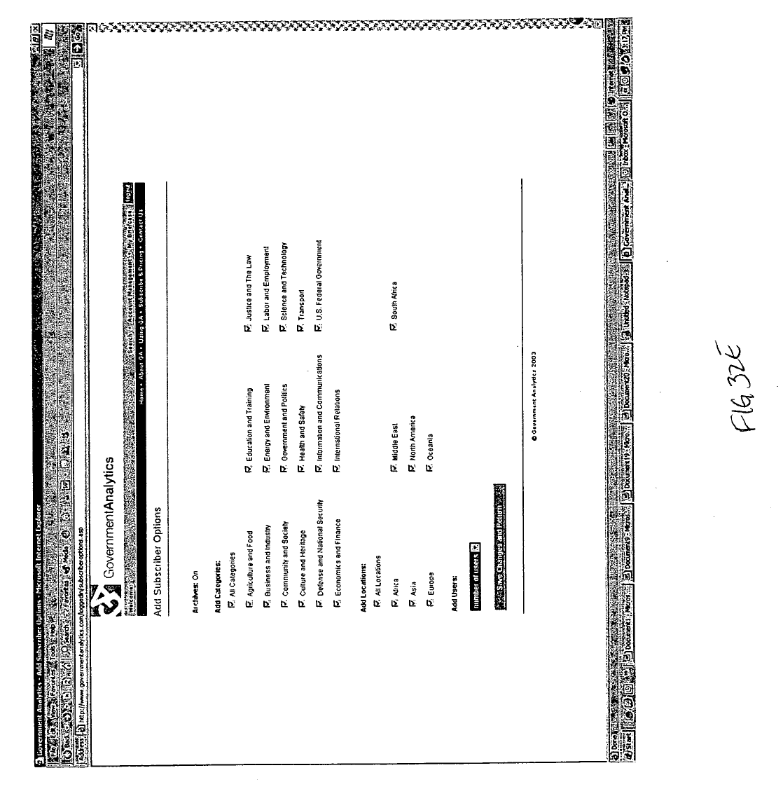

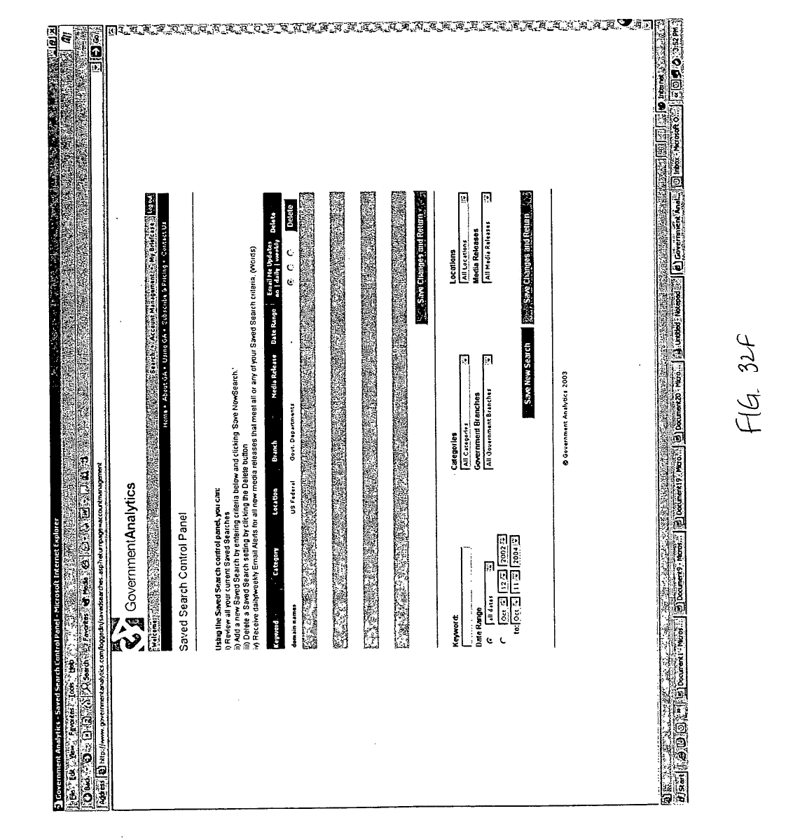

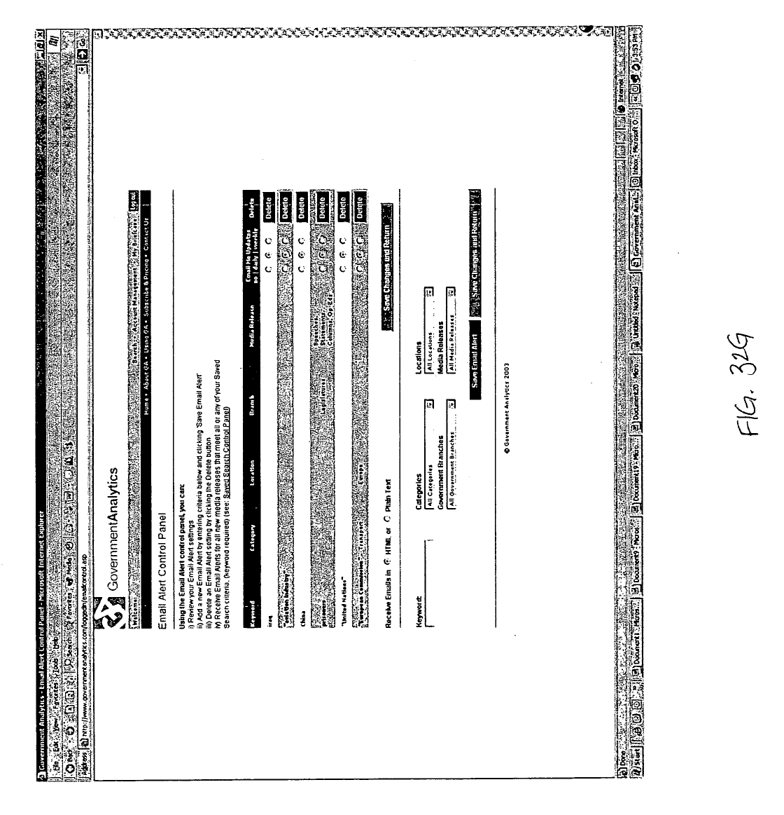

The system may also be configured to provide account management functionality to efficiently manage access to their account. As shown in FIG. 32A, a user would first login to their account. Upon successful login, an account management screen 3200 may be provided, as indicated in FIG. 32B. A user may then select one or more management options such as, for example, subscriber profile subscription options including password changes, saved search control, email alert control, managing the user's briefcase, and/or other management options, as shown in FIGS. 32C-32H. A user may access account management screen 3200 at any time by selecting an Account Management link, such as, for example, Account Management link 3202. Thus, a user may search and/or browse for harvested items, save searches, and/or save specific items of interest.

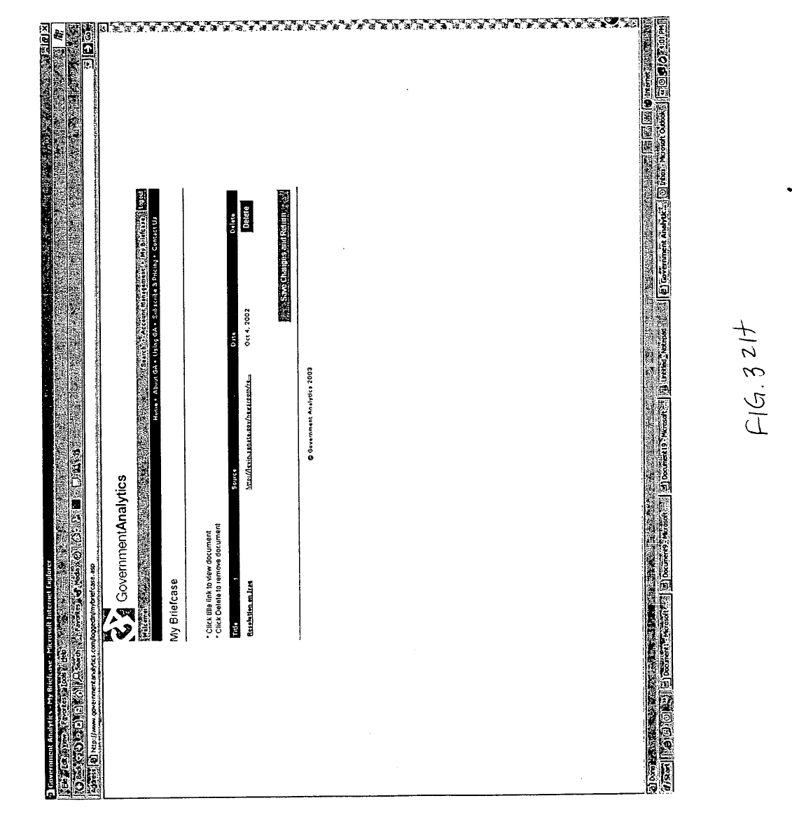

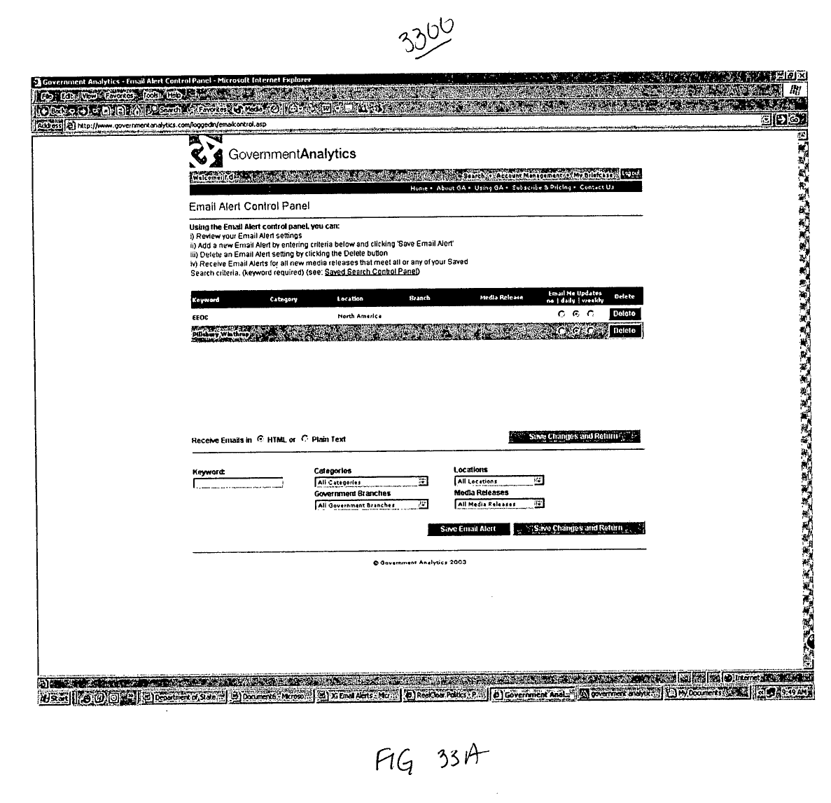

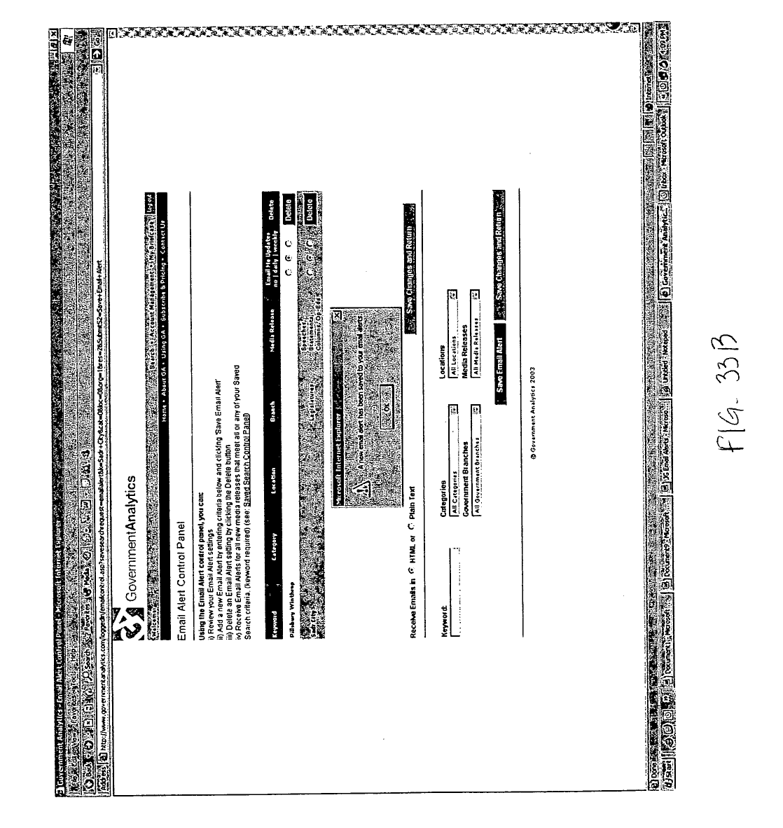

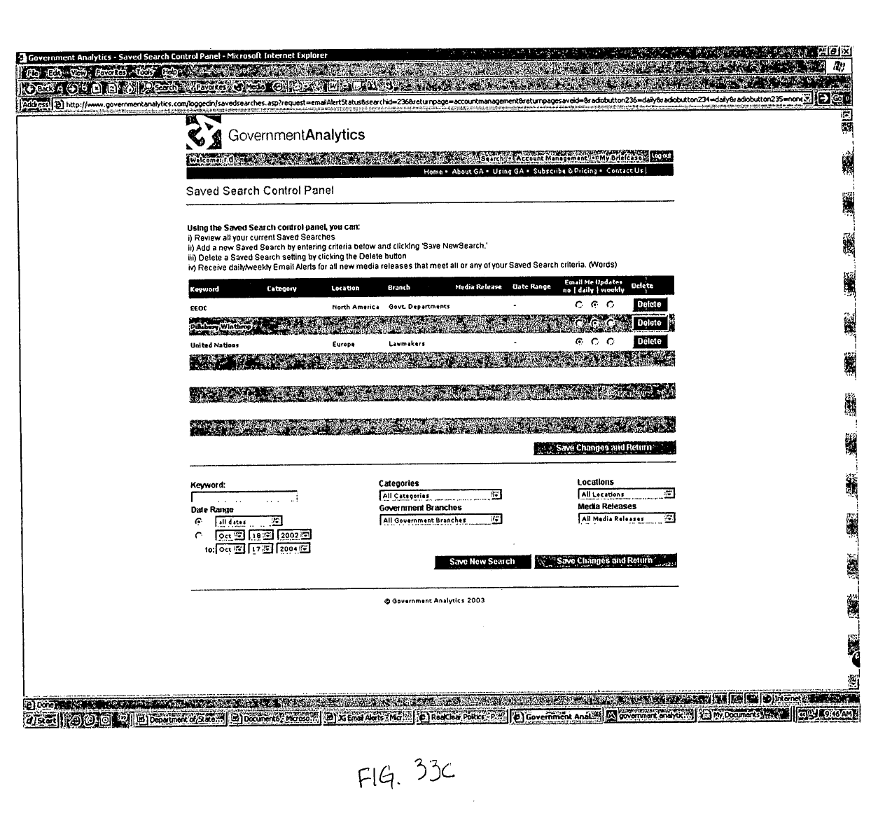

As discussed above, the system may also be configured to provide email notification to alert users to a variety of information including, but not limited to, new newly available release information. In one embodiment, the system provides for an email alert control panel 3300, as indicated in FIG. 33A. The email alert panel 3300 enables users to review and delete email settings, enter, confirm, or otherwise edit search criteria that would trigger email notifications, and receive email notifications for new release information consistent with the search criteria, as indicated by FIG. 33B. Additionally, the email alert panel 3300 also provides the option of receiving email notifications at different time intervals, as shown in FIG. 33C.

In the foregoing specification, the invention has been described with reference to specific embodiments thereof. However, various modifications and changes may be made thereto without departing from the broader spirit and scope of the invention. The specification and drawings are, accordingly, to be regarded in an illustrative sense rather than a restrictive sense.

What is claimed is:

1. A system that automatically collects, processes, and presents information from pre-selected websites, the system comprising:
a training module that enables an administrative user to select a plurality of websites as information source websites, wherein for each of the selected information source websites the training module enables the administrative user to create rules for collecting information from the information source website;
a web retrieval module that collects information from the information source websites in accordance with the rules created via the training module; and
a presentation module that enables an end user to access the collected information via a single website.

2. The system of claim 1, further comprising an indexing module that creates a searchable index of the collected information, and wherein the presentation module enables the end user to access selected information by searching the index.

3. The system of claim 1, further comprising an editing module that enables the administrative user to edit the collected information.

4. The system of claim 1, further comprising a subscriptions module that determines whether to provide access for the end user to the collected information based on a subscription of the end user to the system.

5. The system of claim 4, wherein the subscriptions module determines a first subset of the collected information that the end user is provided access to and a second subset of the collected information that the end user is not permitted to access, based on the subscription of the end user to the system.

6. A method of creating rules for harvesting information from a website, the method comprising:
accessing a website for harvesting;
determining a format of the information to harvested from the website, wherein determining the format comprises:
(i) identifying a first information item on the website; and
(ii) identifying one or more properties of the first information item;
indicating an approach used to identify additional information items on the website; and
setting one or more options associated with the harvesting of the website.

7. The method of claim 6, further comprising harvesting information items from the website based on the determined format according to the one or more set options, wherein the information items are identified using the indicated approach.

8. The method of claim 7, wherein the first information item is a press release, a speech, or a statement, and wherein the additional information items include press releases, speeches, and statements.

9. The method of claim 6, wherein identifying one or more properties of the first information item comprises identifying one or more of a title, a date, a description, a link, a table, or substantive content of the first information item.

10. The method of claim 6, wherein the indicated approach comprises a forms approach and/or a spidering approach, wherein the forms approach comprises automatically filling in forms to obtain access to additional information items, and wherein the spidering approach comprises automatically identifying additional information items in web pages linked within the website.

11. The method of claim 6, wherein the one or more set options comprises one or more of a topical category of information items to be retrieved, a harvesting schedule, or a type of information item to be harvested.

12. The method of claim 7, further comprising creating a searchable index of the harvested information items.

13. The method of claim 7, further comprising providing access for one or more end users to the harvested information via a single website.

14. The method of claim 7, further comprising:
creating a searchable index of the harvested information items; and
providing access for one or more end users to the harvested information via a single website by enabling the one or more end users to search the index on the single website.

15. A method of accessing information harvested from a plurality of websites, the method comprising:
enabling an end user to access a single website that provides access to information harvested from a plurality of other websites;
receiving search criteria from the end user, wherein the end user inputs the search criteria via the single website;
searching a searchable index of the harvested information for information that satisfies the search query; and
providing at least a portion of the information that satisfies the search query to the user.

16. The method of claim 15, wherein providing at least a portion of the information that satisfies the search query to the user comprises providing the information to the user via the single website.

17. The method of claim 15, wherein the search query comprises one or more of a keyword. a topical category, an information item type, a date, or a range of dates.

18. The method of claim 15, wherein the portion of the information that satisfies the search criteria that is provided to the end user is determined based on a subscription of the end user.

19. The method of claim 15, further comprising enabling the user to save the search criteria such that the search of the harvested information based on the saved search criteria will be updated on a predetermined schedule.

20. The method of claim 19, further comprising generating a notification to the end user that the search of the harvested information based on the saved search criteria has been updated, wherein the notification includes information from the harvested information that satisfies the search criteria that has not previously been provided to the end user.
